(19) United States
(12) Patent Application Publication
(10) Pub. No.: US 2015/0249870 A1
(43) Pub. Date: Sep. 3, 2015

(54) IMAGE DISPLAY APPARATUS, EXTERNAL INFORMATION TERMINAL AND PROGRAM TO BE EXECUTED THEREBY

(71) Applicant: Kabushiki Kaisha Toshiba, Tokyo (JP)

(72) Inventor: Mitsue Sato, Saitama Saitama (JP)

(21) Appl. No.: 14/624,369

(22) Filed: Feb. 17, 2015

Related U.S. Application Data
(63) Continuation of application No. PCT/JP2014/055049, filed on Feb. 28, 2014.

(51) Int. Cl. H04N 21/81; H04N 21/633; H04N 21/435

(52) U.S. Cl. CPC H04N 21/812; H04N 21/435; H04N 21/633

(57) ABSTRACT

According to one embodiment, an image display apparatus includes an auto content recognition module configured to automatically recognize a feature of content delivered, a communication module configured to transmit and receives information to and from an external information terminal, and a controller configured to acquire advertisement information associated with the content from a server which stores the advertisement information associated with the content, based on the feature of the content which is recognized by the auto content recognition module, and configured to transmit the advertisement information to the external information terminal in response to an operation by a user which is performed as a trigger.

### CROSS REFERENCE TO RELATED APPLICATIONS

This application is a Continuation Application of PCT Application No. PCT/JP2014/055049, filed Feb. 28, 2014, the entire contents of which are incorporated herein by reference.

### FIELD

Embodiments described herein relate generally to an image display apparatus, an external information terminal and a program to be executed by the external information terminal.

### BACKGROUND

An Auto Content Recognition (ACR) technique is a technique of automatically recognizing and specifying content. A television receiver (image display apparatus) having an ACR function can display in real time an advertisement conforming to a CM or a program which is being presently viewed. The television receiver having the ACR function applies the ID of the CM or the program which is being presently viewed (CM ID or program ID) as a key to acquire advertisement information such as an ID of an associated advertisement content (advertisement ID), and then applies the acquired advertisement ID as a key to download advertisement content. The television receiver having the ACR function can provide an advertisement associated with the CM or program being presently viewed to a user, by superimposing the downloaded advertisement content on the CM or program.

### BRIEF DESCRIPTION OR THE DRAWINGS

A general architecture that implements the various features of the embodiments will now be described with reference to the drawings. The drawings and the associated descriptions are provided to illustrate the embodiments and not to limit the scope of the invention.

FIG. 1 is a view showing an example of a transmission and reception system according to a first embodiment;

FIG. 2 is a view showing an image processing apparatus;

FIG. 3 is a view showing a portable information terminal;

FIG. 4 is a view showing an example of a displayed image of an application for ACR;

FIG. 5 is a view showing an example of another displayed image of the application for ACR;

FIG. 6 is a view showing an example of processing of a television receiver;

FIG. 7 is a view showing an example of processing of a portable information terminal;

FIG. 8 is a view showing an example of processing of the transmission and reception system;

FIG. 9 is a view showing an example of a transmission and reception system according to a first embodiment;

FIG. 10 is a view showing another example of the transmission and reception system according to the first embodiment;

FIG. 11 is a view showing an example of a transmission and reception system according to a second embodiment;

FIG. 12 is a view showing an example of a displayed image of an application for ACR in the second embodiment;

FIG. 13 is a view showing an example of another displayed image of an application for ACR in the second embodiment;

FIG. 14 is a view showing processing of a television receiver in the second embodiment;

FIG. 15 is a view showing an example of processing of a portable information terminal in the second embodiment;

FIG. 16 is a view showing an example of processing of the transmission and reception system according to the second embodiment;

FIG. 17 is a view showing an example of a transmission and reception system according to a third embodiment;

FIG. 18 is a view showing an example of a displayed image of an application for ACR in the third embodiment;

FIG. 19 is a view showing an example of another displayed image of the application for ACR in the third embodiment;

FIG. 20 is a view showing an example of processing of a television receiver in the third embodiment;

FIG. 21 is a view showing an example of processing of a portable information terminal in the third embodiment; and

FIG. 22 is a view showing an example of processing of the transmission and reception system according to the third embodiment.

### DETAILED DESCRIPTION

Various embodiments will be described hereinafter with reference to the accompanying drawings.

In general, according to one embodiment, a image display apparatus includes: an auto content recognition module configured to automatically recognize a feature of content delivered; a communication module configured to transmit and receives information to and from an external information terminal; and a controller configured to acquire advertisement information associated with the content from a server which stores the advertisement information associated with the content, based on the feature of the content which is recognized by the auto content recognition module, and configured to transmit the advertisement information to the external information terminal in response to an operation by a user which is performed as a trigger.

Embodiments described herein will be explained with reference to the accompanying drawings.

### First Embodiment

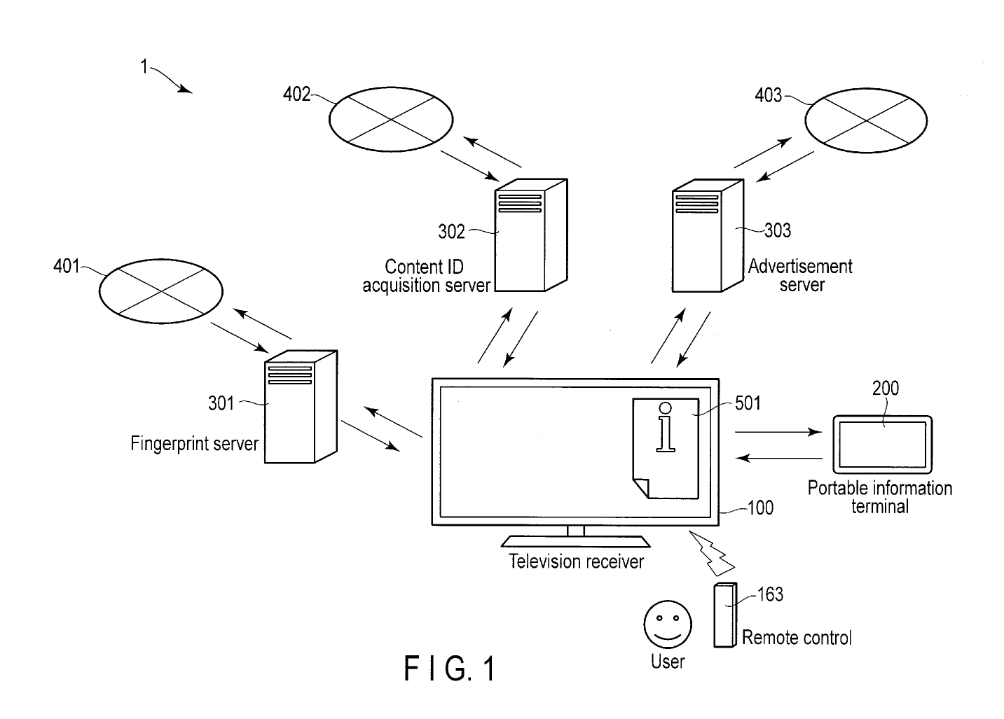

FIG. 1 shows an example of an example of a transmission and reception system 1 to which an embodiment can be applied. It should be noted that elements and structures to be described herein may be provided as elements and structures which can be achieved as those of software by a microcomputer (processing device or a central processing unit (CPU)) or as those of hardware. Furthermore, as a method of acquiring content to be displayed by a monitor module, an arbitrary one of a technique using a space wave (radio wave), a technique using a cable (including an optical fiber) or a network such as an internet protocol communication network, signal processing of a streaming image from the network, an image transfer technique using a network function, etc., can be applied. It should be noted that there is a case where the content is referred to as a stream, a program or information, and the content covers an image, voice, music or the like. The image covers moving images, a still image, and a text (information expressed by a sign or a character indicated by a coded code string) and arbitrary combinations of the moving images, the still image and the text.

A transmission and reception system 1 comprises a plurality of electronic apparatuses such as a television receiver (a sink apparatus or an image display apparatus) 100, a portable information terminal (external information terminal) 200, a fingerprint server 301, a content ID acquisition server 302 and an advertisement server 303.

The television receiver (sink apparatus) 100 is an image processing apparatus incorporating, e.g., a TV (an apparatus equipped with an ACR function) having an Automatic Content Recognition (ACR) function, a broadcasting receiver which can display or reproduce a broadcast signal or image content held by a storage medium or a playback apparatus (recorder) which can record and reproduce content. It should be noted that as the television receiver 100, for example, a recorder (an image record apparatus) which can record content on and display or reproduce content from an optical disk conforming to Blue-ray disk (BD) standards or an optical disk conforming to Digital Versatile Disk (DVD) standards or a hard disk apparatus (HDD), or a set top box (STB) which receives content, and supplies it to the image processing apparatus, may be applied, as long as it can function as a sink apparatus.

The portable information terminal 200 is a terminal device (hereinafter referred to as a potable terminal device) which can be carried, such as a smart phone, a cell phone, a portable telephone terminal which comprises a display module, an operation module and a communication module, a tablet type personal computer (PC), a tablet terminal, a portable music player or a video-game device.

The fingerprint server 301 collects features (fingerprints) of various content, for example, collects information on a program through a network 401 or a cloud service (any of various kinds of servers), and holds the various content as a database. The fingerprint server 301 can communicate with the receiver 100 wirelessly or with a cable. The fingerprint server 301 can provide a fingerprint to the television receiver 100 in response to a request form the receiver 100. The fingerprint server 301 collates fingerprints held in the fingerprint server 301 with information extracted from content which is being viewed with the television receiver 100 or delivered thereto; and extracts a fingerprint conforming to the extracted information. Then, the fingerprint server 301 transmits information of the fingerprint to the receiver 100. It should be noted that the television receiver 100 may be made to have a function of directly extracting a fingerprint from the content which is being viewed or delivered. In this case, the above structure may be set without the fingerprint server 301

The content ID acquisition server 302 collects content IDs through a network 402, e.g., a cloud service (any of various kinds of servers), and holds the content IDs as a database. It should be noted that the content IDs are IDs of various contents, such as an ID of a program which is being viewed or delivered (program ID), and an ID of a CM (CM ID). The content ID acquisition server 302 can communicate with the television receiver 100 wirelessly or with a cable. In response to a request from the television receiver 100, the content ID acquisition server 302 provides various content ID data collected through the network 402 or the cloud service.

The advertisement server 303 collects various advertisement information and advertisement content (first content) 501, and holds them as a database. Also, the advertisement server 303 can communicate with each of the television receiver 100 and the portable information terminal 200 wirelessly or with a cable. In response to a request from the television receiver 100, the advertisement server 303 can provide the advertisement information and the advertisement content 501 to the television receiver 100 and the portable information terminal 200. It should be noted that the advertisement information correspond to, for example, information on an image and audio forming the advertisement content, an ID of the advertisement content 501 (advertisement ID), a text of the advertisement content 501 and a text of an advertisement. Furthermore, the advertisement content 501 is content such as a commercial message (CM) of a shop, an enterprise, a service or a product, an explanation of a product or a service (a feature and a price of the product, a market, a shop, etc.), sell information on a specified shop, a recommendation, word of mouth for a product or the like.

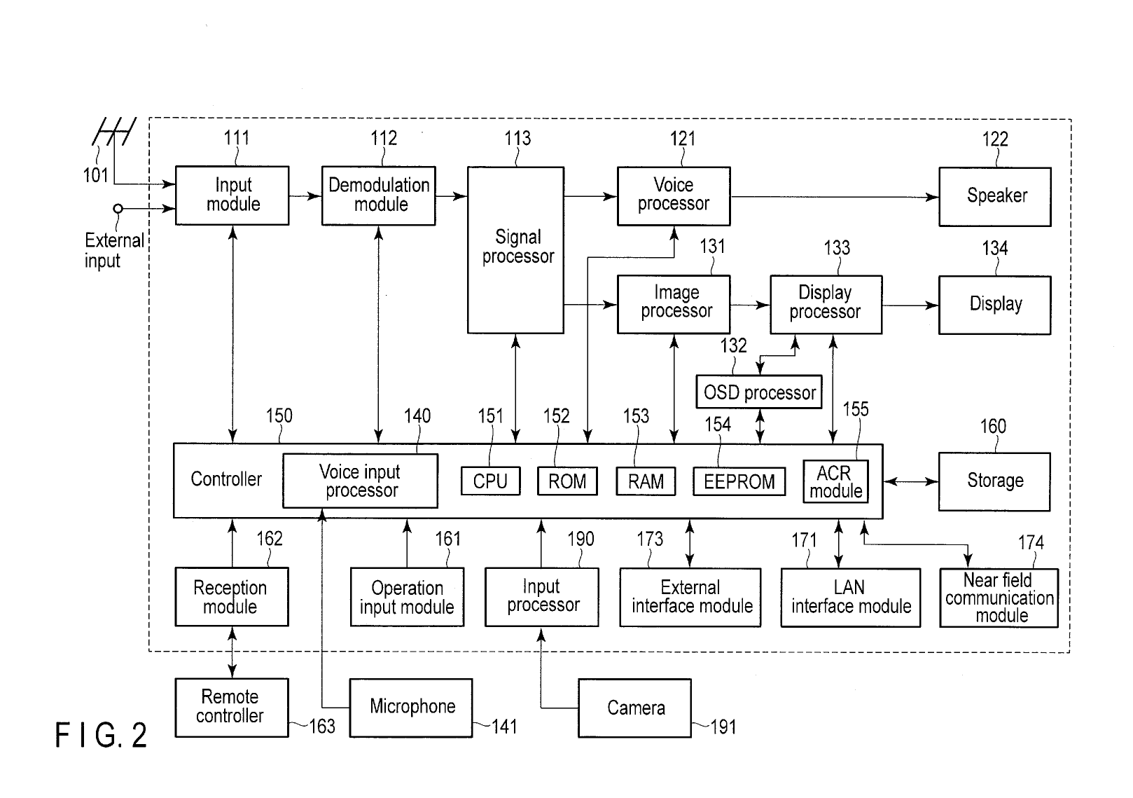

FIG. 2 shows an example of an image processing apparatus.

The image processing apparatus (television receiver) 100 comprises an input module 111, a demodulation module 112, a signal processer 113, an voice processor 121, an image processor 131, an OSD processor 132, a display processor 133, a controller 150, a storage 160, the operation input module 161, a reception module 162, a LAN interface 171, an external interface module 173 and a near field communication module 174. Furthermore, the image processing apparatus 100 also comprises a speaker 122 and a display 134. It should be noted that the image processing apparatus 100 receives a control input (operation instruction) from a remote controller 163, and supplies a control command associated with the operation instruction (control input) to the controller 150.

The input module 111 can receive a digital broadcast signal receivable by, e.g., an antenna 101, such as a digital terrestrial broadcast signal, a broadcasting satellite (BS) digital broadcast signal and/or a communication satellite (CS) digital broadcast signal. Also, the input module 111 can receive content (external input) supplied through, e.g., an STB, or supplied as a direct input.

The input module 111 then performs tuning (channel selection) on the received digital broadcast signal. The input module 111 supplies the digital broadcast signal subjected to the tuning to the demodulation module 112. It should be noted that needles to say, the external input supplied through the STB or the like is supplied to the demodulation module 112 as it is.

Also, it should be noted that the television receiver 100 may comprise a plurality of input modules (tuners) 111. In this case, the television receiver 100 can receive a plurality of digital broadcast signals/content at the same time.

The demodulation module 112 demodulates the digital broadcast signal/content subjected to channel selection. That is, the demodulation module 112 acquires moving image data (hereinafter referred to a stream) such as a transport stream (TS), from the digital broadcast signal/content. The demodulation module 112 inputs the acquired stream to the signal processor 113. It should be noted that the image processing apparatus 100 may comprise a plurality of demodulation modules 112. The plurality of demodulation modules 112 can demodulate a plurality of digital broadcast signals/content, respectively.

As described above, the antenna 101, the input module 111 and the demodulation module 112 function as reception means for receiving the stream.

The signal processor 113 performs signal processing such as separation processing for the stream. To be more specific, the signal processor 113 separates the stream into a digital image signal, a digital voice signal and other data signals such as an electric program guide (EPG) and text data which comprises codes and characters and which is referred to as data broadcast. It should be noted that the signal processor 113 can separate a plurality of streams demodulated by the plurality of demodulation module 112.

The signal processor 113 supplies the digital voice signal to the voice processor 121, which branches from the signal processor 113. Also, the signal processor 113 supplies the digital image signal to the image processor 131, which branches from the signal processor 113. Furthermore, the signal processor 113 supplies data signals such as EPG data, an image and voice to the controller 150.

It should be noted that under control by the controller 150, the signal processor 113 can convert the above stream into data (video-recording stream) which is in a recordable state. Also, the signal processor 113 can supply the video-recording stream to the storage 160 or another module under control by the controller 150.

Furthermore, the signal processor 113 can convert (transcode) a bit rate of the stream from a bit rate set in an original (broadcast signal/content) to another bit rate. That is, the signal processor 113 can convert (transcode) a bit rate of an original of an acquired broadcast signal/content to a lower bit rate. Thereby, the signal processor 113 can video-record content (program) with a smaller capacity.

The voice processor 121 converts the digital voice signal received from the signal processor 113 into a signal (audio signal) having a format in which the signal can be reproduced by the speaker 122. To be more specific, the voice processor 121 includes a digital-to-analog (D/A) converter, and converts the digital voice signal into an analog audio/voice signal. The voice processor 121 supplies the audio/voice signal obtained by conversion to the speaker 122. The speaker 122 reproduces voice and audio from the supplied audio/voice signal.

The image processor 131 converts the digital image signal from the signal processor 113 into an image signal having a format in which the image signal can be reproduced by the display 134. That is, the image processor 131 decodes the digital image signal from the signal processor 113 into an image signal having a format in which the image signal can be reproduced by the display 134. The image processor 131 outputs the image signal obtained by decoding to the display processor 133.

The OSD processor 132 produces an on-screen display (OSD) signal for causing an image to be superimposed on a display signal from the image processor 131, based on a data signal supplied from the signal processor 113 and/or a control signal (control command) supplied from the controller 150. The image to be superimposed on the display signal is, for example, the following indication: a Graphical User Interface (GUI) indication; a caption; time; a message indicating that the application can be applied or not; a notice of voice communication with or reception of communication data to the portable information terminal 200, which is superimposed on audio and image being reproduced; or advertisement content acquired with an ACR function.

The display processor 133 performs image quality adjustment of color, brightness, sharpness, contrast or the like on the received image signal, for example, under control by the controller 150. The display processor 133 supplies the image signal subjected to the image-quality adjustment to the display 134. Therefore, the display 134 displays an image based on the supplied image signal.

Also, the display processor 133 superimposes the image signal subjected to the image-quality adjustment, which is supplied from the image processor 131, and the OSD signal from the OSD processor 132 together, and supplies those signals to the display 134.

The display 134 comprises, for example, a liquid crystal display apparatus which includes: a liquid crystal panel comprising a plurality of pixels arranged in a matrix; and a backlight which illuminates the liquid crystal panel. The display 134 displays an image based on the image signal supplied from the display processor 133.

It should be noted that the television receiver 100 may comprise an output terminal which outputs the image signal, instead of the display 134. Also, the television receiver 100 may comprise an output terminal which outputs an audio signal, instead of the speaker 122. Furthermore, the image processing apparatus 100 may comprise an output terminal which outputs the digital image signal and the digital voice signal.

The controller 150 functions as control means for controlling operations of modules of the television receiver 100. The controller 150 comprises a CPU 151, a ROM 152, a RAM 153, an EEPROM (nonvolatile memory) 154, an ACR module 155, etc. The controller 150 performs various processing based on an operation signal supplied from the operation input module 161.

The CPU 151 comprises an arithmetic element which performs various arithmetic processing, etc. The CPU 151 executes a program stored in the ROM 152, the EEPROM 154 or the like to fulfill various functions.

The ROM 152 stores a program for controlling the television receiver 100, a program for fulfilling various functions, etc. The CPU 151 starts a program stored in the ROM 152 based on an operation signal supplied from the operation input module 161. Thereby, the controller 150 controls operations of modules.

The RAM 153 functions as a work memory of CPU 151. That is, the RAM 153 stores an arithmetic result obtained by the CPU 151, data read by the CPU 151, etc.

The EEPROM 154 is a nonvolatile memory which stores various set information, a program, etc.

The ACR module 155 automatically recognizes feature data of the content supplied from the signal processor 113, and causes the CPU 151 to execute processing for extracting one or more feature data from content to be recognized which is being viewed or delivered. It should be noted that the feature data is data on an object or a person displayed in association with the content being viewed, entire image data or part of image data, voice data, data included in a content signal or the like. The extracted feature data is transmitted to the fingerprint server 301, and collated with fingerprints stored in advance as a database. It should be noted that the ACR module 155 is held as a program in a nonvolatile memory, for example, the ROM 152 or the storage 160.

The storage 160 includes a storage medium which stores content. The storage 160 is, for example, a hard disk drive (HDD), a solid state drive (SSD), a semiconductor memory or the like. The storage 160 can store a video-recording stream, text data or the like which is supplied from the signal processor 113, various servers (the fingerprint server 301, the content ID acquisition server 302, the advertisement server 303, etc.), the portable information terminal 200, or the like.

The operation input module 161 comprises touch pads or operation keys which produces an operation signal in accordance with an operation input by, e.g., a user, etc. Furthermore, the operation input module 161 may be configured to receive an operation signal from a keyboard, a mouse or an input device which can produce an operation signal. The operation input module 161 supplies the operation signal to the controller 150. It should be noted that the operation input module 161 may be configured to receive a signal from the portable information terminal 200 through the LAN interface module 171 and the near field communication module 174, and produce an operation signal.

It should be noted that the touch pads includes a capacitance type sensor, a thermo-sensor or a device which produces position information based on a method other than those of the capacitance type sensor and the thermo-sensor. Furthermore, in the case where the television receiver 100 comprises the display 134, the operation input module 161 may comprise a touch panel, etc., such that the touch panel and the display 134 are formed as a single body.

The reception module 162 comprises a sensor which receives an operation signal supplied from the remote controller 163 with an infrared (Ir) method, etc. The reception module 162 supplies the received signal to the controller 150. After receiving and amplifying the signal supplied from the reception module 162, the controller 150 performs analog-to-digital conversion on the signal to thereby decode it into an original operation signal, which is transmitted from the remote controller 163.

The remote controller 163 produces an operation signal based on an operation input by the user. The remote controller 163 then transmits the produced operation signal to the reception module 162 through infrared communication. It should be noted that the reception module 162 and the remote controller 163 may be configured to transmit and receive the operation signal through another wireless communication such as a radio wave (RF).

The LAN (Local Area Network) interface 171 can communicate with various servers (the fingerprint server 301, the content ID acquisition server 302, the advertisement server 303, servers on networks 401, 402 and 403, etc.) and another device via a wireless communication terminal through a LAN or wireless LAN. Thereby, the image processing apparatus 100 can communicate with a device connected to the wireless communication terminal. For example, the image processing apparatus 100 can acquire and reproduce streams recorded in devices on the networks 401, 402 and 403 through the LAN interface 171.

The external interface module 173 is an interface which performs communication based on standards such as HDMI or MHL. The external interface module 173 comprises an HDMI terminal not shown to which, for example, an HDMI cable or an MHL cable can be connected, an HDMI processor which executes signal processing based on HDMI standards, and an MHL processor which executes signal processing based on MHL standards. It should be noted that a terminal of the MHL cable, which is to be connected to the image processing apparatus, is compatible with the HDMI cable. Also, in the MHL cable, a resistor is connected between terminals (terminals for detection) which are not applied to communication. It should be noted that the external interface module 173 applies a voltage to the terminal for detection to recognize whether the MHL cable is connected to the HDMI terminal or the HDMI cable is connected thereto.

The television receiver 100 can receive and reproduce data output from an apparatus (source apparatus) connected to the HDMI terminal of the external interface module 173. Also, the television receiver 100 can output data to another apparatus (sink apparatus) connected to the HDMI terminal of the external interface module 173.

The near field communication module 174 is a communication device which transmits and receives data to and from the portable information terminal 200 through near field communication. The near field communication module is, for example, Bluetooth (registered trademark). A signal transmitted from the portable information terminal 200 and received by the near field communication module 174 is sent to the controller 150, and transmitting and receiving processing of data is executed by the CPU 151. It is possible to transmit and receive data, for example, the advertisement information, an identification number of the portable information terminal 200, an identification number of the television receiver 100, user information, etc., simply by holding the portable information terminal 200 over the near field communication module 174.

The controller 150 supplies data (information) received by the external interface module 173 and the near field communication module 174 to the signal processor 113. The signal processor 113 separates the received (supplied) data into a digital image signal, a digital voice signal, etc. The signal processor 113 transmits the digital image signal to the image processor 131, and also the digital voice signal to the voice processor 121. Thereby, the television receiver 100 can display the data received by the external interface module 173 and the near field communication module 174. In this case, the ACR module 155 automatically recognizes feature data of content from the received data, and causes the CPU 151 to execute processing for extracting one or more feature data of the content. The television receiver 100 acquires advertisement content 501 through communication with various servers (the fingerprint server 301, the content ID acquisition server 302 and the advertisement server 303) based on the extracted feature data. The television receiver 100 can display the acquired advertisement content 501 on an image signal from the image processor 131. Also, the television receiver 100 can transmit the advertisement information acquired through the external interface module 173 and the near field communication module 174 to the portable information terminal 200.

Furthermore, the television receiver 100 comprises a power supply module not shown. The power supply module receives power from a commercial power supply or the like through an AC adaptor or the like. The power supply module converts received AC power into DC power, and supplies the power to modules provided in the television receiver 100.

It should be noted that the television receiver 100 includes an input processor 190 and a camera 191 connected to the input processor 190. An image (of the user) which is acquired by the camera 191 is input to the controller 150 through the input processor 190, and is subjected to predetermined processing and digital signal processing by the signal processor 113 connected to the controller 150.

Furthermore, the television receiver 100 comprises a voice input processor 140 connected to the controller 150, and can process starting and ending of a call based on voice information acquired by a microphone 141.

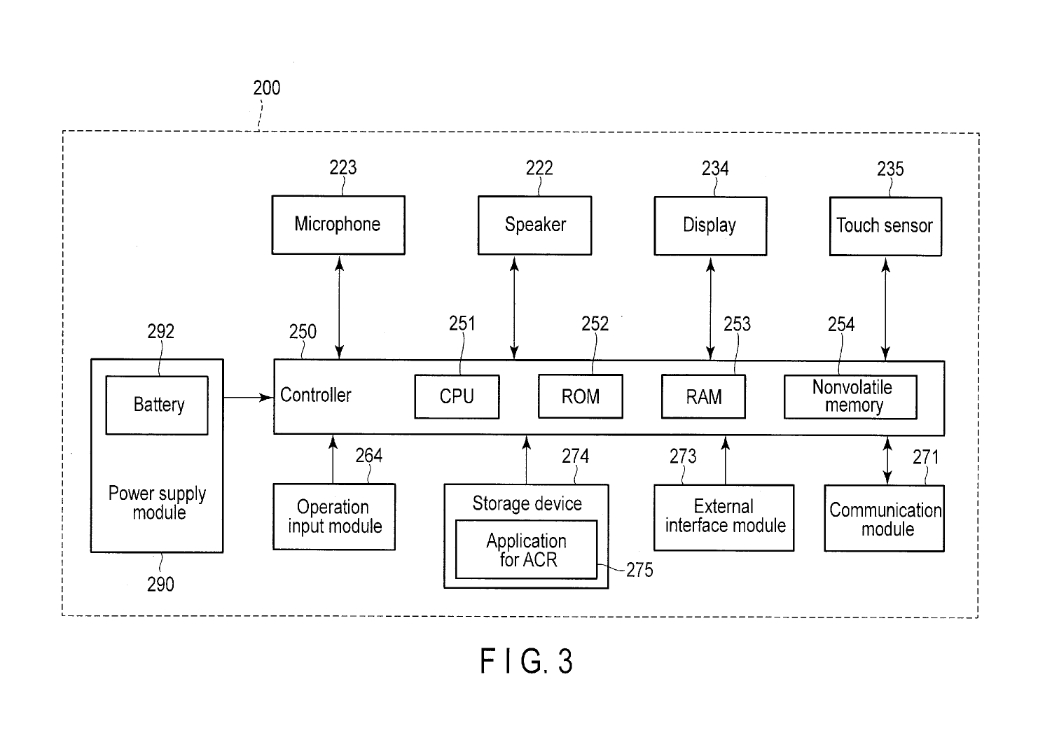

FIG. 3 shows an example of the portable information terminal 200.

The portable information terminal (source device) 200 comprises a controller 250, an operation input module 264, a communication module 271, an MHL processor 273 and a storage device 274 which holds an application 275 for ACR. The portable information terminal 200 further comprises a speaker 222, a microphone 223, a display 234 and a touch sensor 235.

The controller 250 functions as a controller which controls operations of the modules in the portable information terminal 200. The controller 250 comprises a CPU 251, a ROM 252, a RAM 253, a nonvolatile memory 254, etc.

The controller 250 executes various processing based on an operation signal supplied from the operation input module 264 or the touch sensor 235. Also, the controller 250 executes a module control which is associated with a control command given from the television receiver 100, starting of an application or processing provided by the application (execution of a function) (there is a case where those processing is executed by the CPU 251).

The CPU 251 comprises an arithmetic element which executes various arithmetic processing, etc. The CPU 251 performs various functions by executing programs stored in the ROM 252, the nonvolatile memory 254 or the like.

The CPU 251 can execute various processing based on data such as an application stored in the storage device 274. The CPU 251 executes a module control associated with a control command given from the television receiver 100 through an MHL cable 10, starting of an application and processing provided by the application (execution of a function).

The ROM 252 stores a program for controlling the portable information terminal 200, a program for performing various functions, etc. The CPU 251 starts the program stored in the ROM 252 based on the operation signal from the operation input module 264. Thereby, the controller 250 controls operations of the modules.

The RAM 253 functions as a work memory of the CPU 251. To be more specific, the RAM 253 stores an arithmetic result obtained by the CPU 251, data read by the CPU 251, etc.

The nonvolatile memory 254 is a nonvolatile memory which stores various set information, programs, etc.

Furthermore, the controller 250 can produce an image signal for display which is associated with any of various images, in accordance with an application executed by the CPU 251, and causes it to be displayed by the display 234. Therefore, the display 234 displays or reproduces moving images (graphic), a still image or character information based on a video signal supplied. Furthermore, the controller 250 can produce a voice signal for reproduction, which is associated with any of various voices in accordance with an application executed by the CPU 251, and cause it to be output from the speaker 222. Therefore, the speaker 222 reproduces sound (audio/voice) based on an audio signal supplied.

The microphone 223 collects sound of surroundings of the portable information terminal 200, and produces an audio signal. After subjected to AD conversion, the audio signal is converted into audio data by the controller 250; and the audio data is temporarily held in the RAM 253. After subjected to DA conversion as occasion demands, the audio data is converted into voice/audio sound by the speaker 222 (it is reproduced). Also, after subjected to AD conversion, the audio data is used as a control command by voice recognition processing.

The display 234 comprises a liquid crystal display apparatus which comprises: a liquid crystal panel, for example, including a plurality of elements arranged in a matrix; and a backlight which illuminates the liquid crystal panel, etc. The display 234 displays an image based on an image signal.

The touch sensor 235 is a capacitance type sensor, a thermo-sensor, or a device which produces position information based on a method other than those of the capacitance type sensor and the thermo-sensor. For example, the touch sensor 235 and the display 234 are provided as a single body. Thereby, the touch sensor 235 can produce an operation signal based on an operation on an image displayed by the display 234, and supply it to the controller 250. It should be noted that in the case where the input operation is performed with buttons, the touch sensor 235 need not to be provided.

The operation input module 264 comprises keys for producing an operation signal in accordance with, for example, an operation input by the user. Also, the operation input module 264 comprises, e.g., a volume adjustment key for adjusting a volume, a brightness adjustment key for adjusting a display brightness of the display 234 and a power supply key for switching a power-supply state of the portable information terminal 200 (turning on/off it). The operation input module 264 may further comprise a track ball for causing the portable information terminal 200 to perform various selection operations, etc. The operation input module 264 produces an operation signal in response to an operation of any of the above keys, and supplies the operation signal to the controller 250.

Furthermore, the operation input module 264 may be configured to receive an operation signal from a keyboard, a mouse or an input device which can produce the operation signal. For example, in the case where the portable information terminal 200 includes a USB terminal, a Bluetooth-compatible module or the like, the operation input module 264 receives an operation signal from an input device connected thereto by a USB or Bluetooth, and supplies it to the controller 250.

The communication module 271 can communicate with devices on the networks 401, 402 and 403 via the wireless communication terminal through the LAN or wireless LAN. Furthermore, the communication module 271 can communicate with the devices on the networks 401, 402 and 403 via a mobile telephone network. Thereby, the portable information terminal 200 can communicate with a device connected to the wireless communication terminal. For example, the portable information terminal 200 acquires from the communication module 271, moving images, a photograph, music data and WEB content, etc., recorded on the devices on the networks 401, 402 and 403, to reproduces those.

An external interface module 273 is an interface to be connected to an external device to perform communication therewith. For example, the external interface module 273 executes processing based on MHL standards. Also, the external interface module 273 includes a USB terminal to which the MHL cable can be connected.

The portable information terminal 200 receives data output from an apparatus (source apparatus) connected to the external interface module 273 to display an image. Also, the portable information terminal 200 can output data to another apparatus (sink apparatus) connected to the external interface module 273.

Also, the portable information terminal 200 comprises a power supply module 290. The power supply module 290 comprises a battery (rechargeable battery) 292 and a terminal (e.g., a DC jack) for connection to an adapter for receiving power from a commercial power supply or the like. The power supply module 290 charges a battery 292 with the power from the commercial power supply. Also, the power supply module 290 supplies power with which the battery 292 is charged to modules provided in the portable information terminal 200.

The storage device 274 comprises a hard disk drive (HDD), a solid-state drive (SSD), a semiconductor memory or the like. The storage device 274 can store a program and an application which are to be executed by the CPU 251 of the controller 250, content such as moving images, and various data. The storage device 274 holds the application 275 for ACR, which is used in processing advertisement information received from the television receiver 100.

The application 275 for ACR is a program for easily processing advertisement information (displayed advertisement information) of the advertisement content 501, which is displayed by the television receiver 100. It should be noted that the CPU 251 executes processing of the application 275 for ACR upon receipt of a signal from the application 275 for ACR.

The application 275 for ACR connects a communication line from the portable information terminal 200 to the television receiver 100, which is registered in the portable information terminal 200, at the same time as it is started. For example, the application 275 for ACR can set timing of connecting the communication line to time of starting the television receiver 100, time of starting the portable information terminal 200 or time of starting the application 275 for ACR or the like. Furthermore, the application 275 for ACR can be started in a background. For example, if it is started in the background, a button, an icon or the like of the application 275 for ACR is displayed on the display 234. By selecting the icon, the user can select whether the application 275 for ACR is to be started in the background or it is to be started in a foreground.

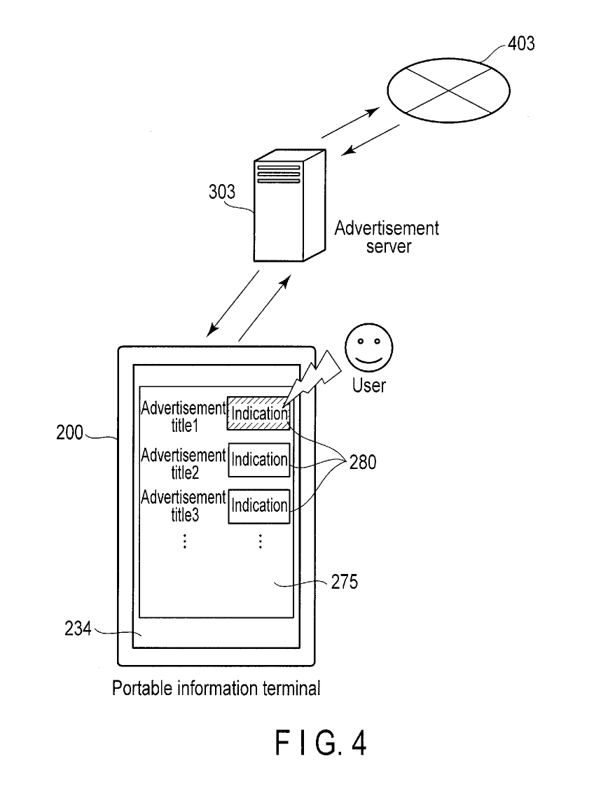

The application 275 for ACR receives a request from the user, e.g., a signal from the remote controller 163, and holds the advertisement information transmitted from the television receiver 100. As shown in FIG. 4, when displaying the held advertisement information, the application 275 for ACR lists it in accordance with the request from the user. For example, the application 275 for ACR may be programmed such that an icon (permutation icon) for permutating the listed advertisement information is displayed in it. If the permutation icon is selected, the advertisement information is displayed in such a manner as to be ordered according to requirements. It should be noted that the permutation icon may be programmed capable of setting requirements for permutation.

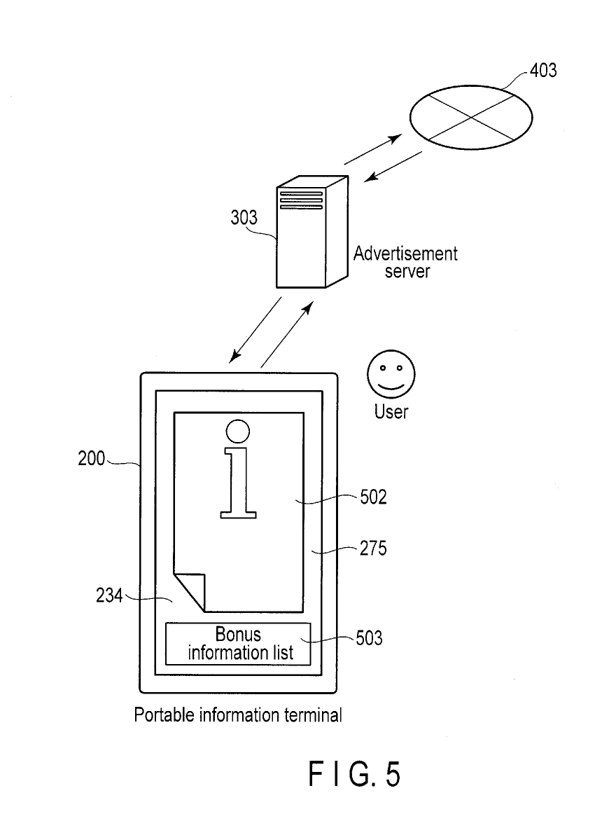

The application 275 for ACR is programmed to cause icons (display icons) 280 to be displayed on the display 234, the icons 280 being each used in displaying detailed information of the advertisement content 501 which is saved while content displayed by the television receiver 100 is being viewed or delivered. If the user selects a display icon 280, further detailed information (advertisement content (second content) 502 for mobile phone) is displayed on the display 234. For example, as shown in FIG. 4, a display icon 280 of advertisement title 1 is displayed at a side of advertisement title 1 (or around advertisement title 1). If the user selects the display icon 280 of advertisement title 1, the application 275 for ACR executes processing for changing the image displayed on the display 234 from an image as shown in FIG. 4 to an image as shown in FIG. 5. During this processing, the portable information terminal 200 transmits advertisement information selected by the user to the advertisement server 303, and receives advertisement content 502 for mobile phone, which corresponds to the advertisement selected by the user, from the advertisement server 303. In such a manner, after the image on the display 234 is changed, the display 234 displays advertisement content 502 for mobile phone, which corresponds to advertisement selected by the user during viewing operation with the television receiver 100. The advertisement content 502 for mobile phone is adjusted (programmed) to cause the advertisement content 501 displayed by the television receiver 100 to conform to the portable information terminal 200.

As shown in FIG. 5, the advertisement content 502 for mobile phone includes an icon (bonus information indication icon) for indicating information (bonus information) useful for the user, e.g., for indicating a coupon ticket. That is, in the image of the application 275 for ACR, a bonus information icon 503 is displayed in addition to the advertisement content 502 for mobile phone. It should be noted that the bonus information icon 503 may be programmed selectable by an operation by the user. For example, if the user selects the bonus information icon 503 with his or her operation, in the image of the application 275 for ACR, bonus information such as a coupon ticket, information on sale items, the date of a sale, etc., is displayed in detail. The user can obtain a bonus, e.g., get a discount on a commodity in a shop by presenting a coupon ticket issued at the shop to the shop. If the user selects the bonus information icon 503, information selected by the user is transmitted to the advertisement server 303. It should be noted that the application 275 for ACR may be set to include a button (purchase button) for purchasing a commodity indicated in the advertisement content 502 for mobile phone. If the user selects the purchase button, purchase information is transmitted to a shop which puts the advertisement, through a serer, e.g., the advertisement server 303.

An example of each of processing of the television receiver 100, that of a portable information device 200 and that of the transmission and reception system 1 will be explained with reference to figures.

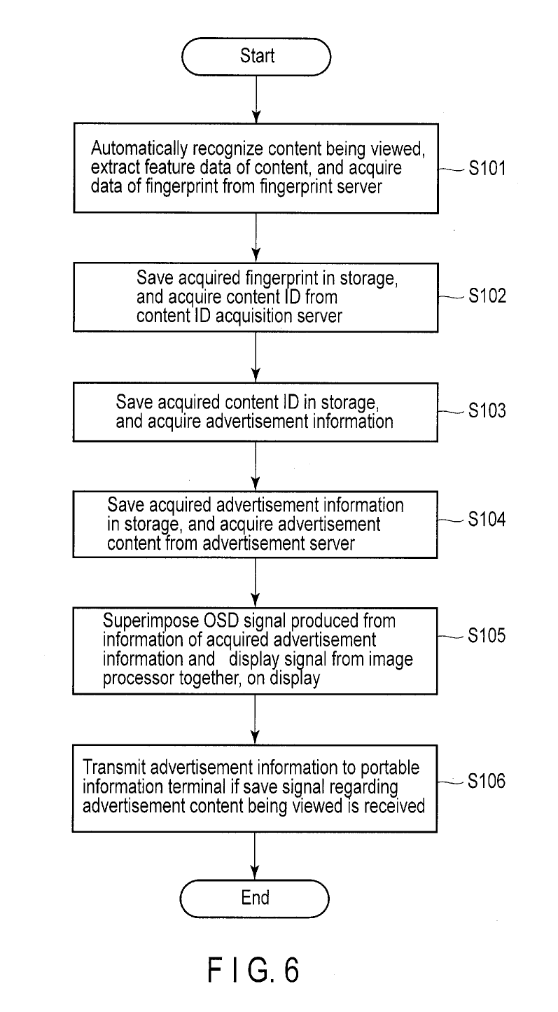

With reference to FIG. 6, an example of the processing of the television receiver 100 will be explained.

In S101, feature data of content being delivered or viewed with the television receiver 100 is automatically recognized by the ACR module 155, and extracted to the CPU 151. At this time, the CPU 151 causes the storage 160 to record the extracted feature data, and transmits the feature data to the fingerprint server 301 through the LAN interface 171. Data from the fingerprint server 301 is received, and data of a fingerprint for content being viewed with the television receiver 100 is acquired. It should be noted that the CPU 151 records the acquired data of the fingerprint in the RAM 153 and the storage 160.

Next, in S102, the CPU 151 transmits the acquired data of the fingerprint to the content ID acquisition server 302. Data from the content ID acquisition server 302 is received, and a content ID of the content being viewed with the television receiver 100 is acquired. It should be noted that the CPU 151 records data of the acquired content ID in the RAM 153 and the storage 160.

In S103, the CPU 151 transmits the acquired content ID to the advertisement server 303.

Advertisement information from the advertisement server 303 is received, and the advertisement information of the content being viewed with the television receiver 100 is acquired. It should be noted that the CPU 151 records the acquired advertisement information in the RAM 153 and the storage 160.

In S104, the CPU 151 transmits advertisement ID of the acquired content of the advertisement information and a device identification number (device identification ID) of the television receiver 100 to the advertisement server 303. The television receiver 100 receives data of advertisement content 501 for television receiver, from the advertisement server 303. It should be noted that the CPU 151 records the data of the advertisement content 501 for television receiver in the RAM 153 and the storage 160.

In S105, the CPU 151 transmits the data of the advertisement content 501 to the OSD processor 132. The OSD processor 132 produces an OSD signal from the advertisement content 501. The produced OSD signal is sent to the display processor 133. The display processor 133 superimposes the OSD signal for the advertisement content 501 on a display signal sent from the image processor 131. An image signal on which the OSD signal is superimposed is sent to the display 134, and the advertisement content 501 is displayed on the screen. It should be noted that it may be set that the user can select whether to display the advertisement content 501 on the display 134 or not, using the remote controller 163.

It should be noted that suppose in order to transmit advertisement information to the portable information terminal 200, the user transmits it to the television receiver 100, using a communication device, for example, the remote controller 163. In this case, the television receiver 100 detects a signal to be output by an operation by the user or detects the operation as a signal (save signal) for saving the advertisement information associated with the advertisement content 501 being viewed or delivered. If the save signal is detected, the CPU 151 of the television receiver 100 saves advertisement information of the advertisement content 501 being viewed in the storage 160, and transmits the advertisement information to the portable information terminal 200. That is, the CPU 151 transmits the advertisement information of the advertisement content 501 being viewed to the portable information terminal, in response to an operation by the user which is performed as a trigger. For example, if the user presses an associated button (e.g., a blue button) at the remote controller 163, the save signal is supplied from the remote controller 163.

In S106, if the save signal associated with the advertisement content 501 is received by the television receiver 100, a communication signal is transmitted to the portable information terminal 200 through the LAN interface 171 or the near field communication module 174. If the communication signal is returned from the portable information terminal 200, the television receiver 100 connects the communication line to the portable information terminal 200. The television receiver 100 transmits the advertisement information to the portable information terminal 200.

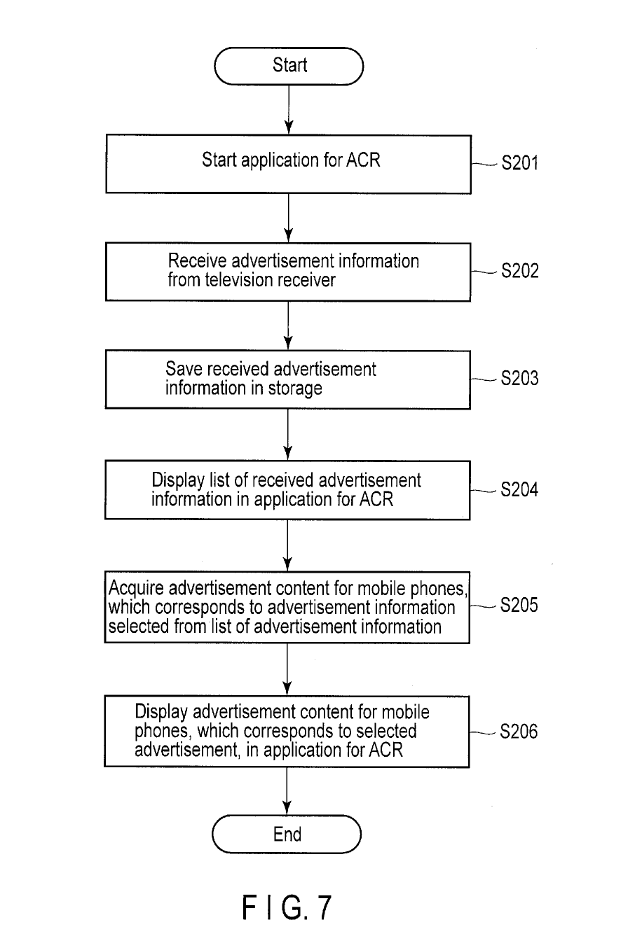

Next, an example of processing of the portable information terminal 200 will be explained with reference to FIG. 7.

In S201, upon receipt of a request from the user (an operation by the user) or a signal from the television receiver 100, the CPU 251 of the portable information terminal 200 starts the application 275 for ACR. In S202, the portable information terminal 200 acquires from the television receiver 100, the advertisement information of the advertisement content 501 transmitted from the television receiver 100 through the communication module 271. That is, the portable information terminal 200 acquires from the television receiver 100, advertisement information associated with the advertisement content 501 stored in the storage 160 in the television receiver 100, for example, an advertisement title, an advertisement ID, etc., through the communication module 271. In S203, the CPU 251 stores the acquired advertisement information associated with the advertisement content 501 in the RAM 253 and the storage device 274. In S204, the CPU 251 prepares a list of the acquired advertisement information associated with the advertisement content 501 in the application 275 for ACR. It should be noted that in the list of the advertisement information, for example, the order of acquisition of advertisement information or the order of titles of advertisements are displayed, or advertisement titles are displayed with respect to each of categories. In S205, if the user selects any one advertisement content 501 from the prepared list by an operation by the user such as a button operation or a touch to the screen, the CPU 251 acquires selected advertisement content 502 for mobile phone from the advertisement server 303 through the application 275 for ACR. In S206, the CPU 251 causes the advertisement content 502 acquired from the advertisement server 303 to be displayed in the application 275 for ACR (the display 234). At this time, on the display 234, bonus information, for example, a coupon ticket, is also displayed.

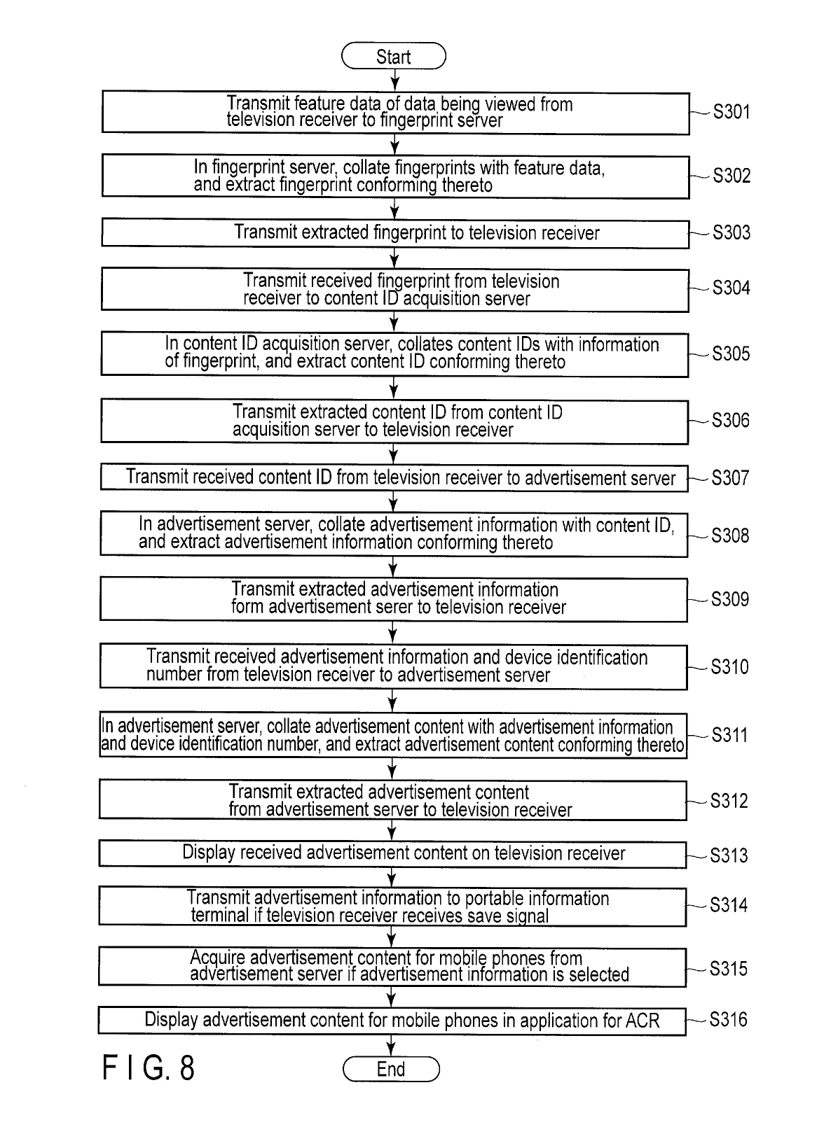

An example of processing of the transmission and reception system 1 will be explained with reference to FIG. 8.

In S301, the television receiver 100 transmits feature data of content being viewed or delivered to the fingerprint server 301. The fingerprint server 301 collects fingerprints of content from the network 401 or a cloud server to prepare a database.

In S302, if receiving the feature data of the content being viewed from the television receiver 100, the fingerprint server 301 collates the feature data and information of the fingerprints in the database with each other, and extracts a fingerprint conforming to the feature data.

In S303, the fingerprint server 301 transmits the extracted fingerprint to the television receiver 100.

In S304, the television receiver 100 stores the received fingerprint in the storage 160 or the like, and transmits it to the content ID acquisition server 302. The content ID acquisition server 302 collects fingerprints and content IDs and holds them as a database. Therefore, in S305, if receiving the fingerprint from the television receiver 100, the content ID acquisition server 302 collates the received fingerprint and content IDs with each other, and extracts a content ID conforming to the received fingerprint. In S306, the content ID acquisition server 302 transmits the extracted content ID to the television receiver 100.

In S307, if receiving the content ID from the content ID acquisition server 302, the television receiver 100 stores the received content ID in the storage 160 or the like, and transmits the content ID and a device identification number to the advertisement server 303. The advertisement server 303 collects content IDs, advertisement information and advertisement content 501, and holds them as a database. In S308, the advertisement server 303 collates the above content ID and device identification number with the collected advertisement information, and extracts advertisement information conforming to the content ID. In S309, the advertisement server 303 transmits advertisement information conforming to a device type determined from the device identification number to the television receiver 100.

In S310, if receiving the advertisement information from the advertisement server 303, the television receiver 100 stores the received advertisement information in the storage, and also transmits an advertisement ID and device identification number of the received advertisement information to the advertisement server 303. In S311, the advertisement server 303 collates advertisement content 501 for television receiver with the advertisement ID and device identification number of the advertisement information, and extracts advertisement content 501 conforming to the received advertisement ID. In S312, the advertisement server 303 transmits advertisement content 501 conforming to a device type determined from the device identification number to the television receiver.

In S313, if receiving the advertisement content 501 from the advertisement server 303, the television receiver 100 stores the received advertisement content 501 in the storage 160 or the like, and causes the advertisement content 501 to be displayed on the display 134.

In S314, if a save signal for saving advertisement content 501 being viewed by the user is output, and is received by the television receiver 100, the television receiver 100 transmits advertisement information of the advertisement content 501 being viewed to the portable information terminal 200. Of the received advertisement information, advertisement information saved in the application 275 for ACR is listed, and titles of the advertisement information are displayed as a list. In S315, if advertisement information to be displayed is selected from the list, and a display button is pressed by the user, the portable information terminal 200 acquires advertisement content 502 for mobile phone from the advertisement server 301. Then, in S316, the acquired advertisement content 502 for mobile phone is displayed with the application 275 for ACR. When the acquired advertisement content 502 for mobile phone is displayed, bonus information 503 is also displayed in the application for ACR.

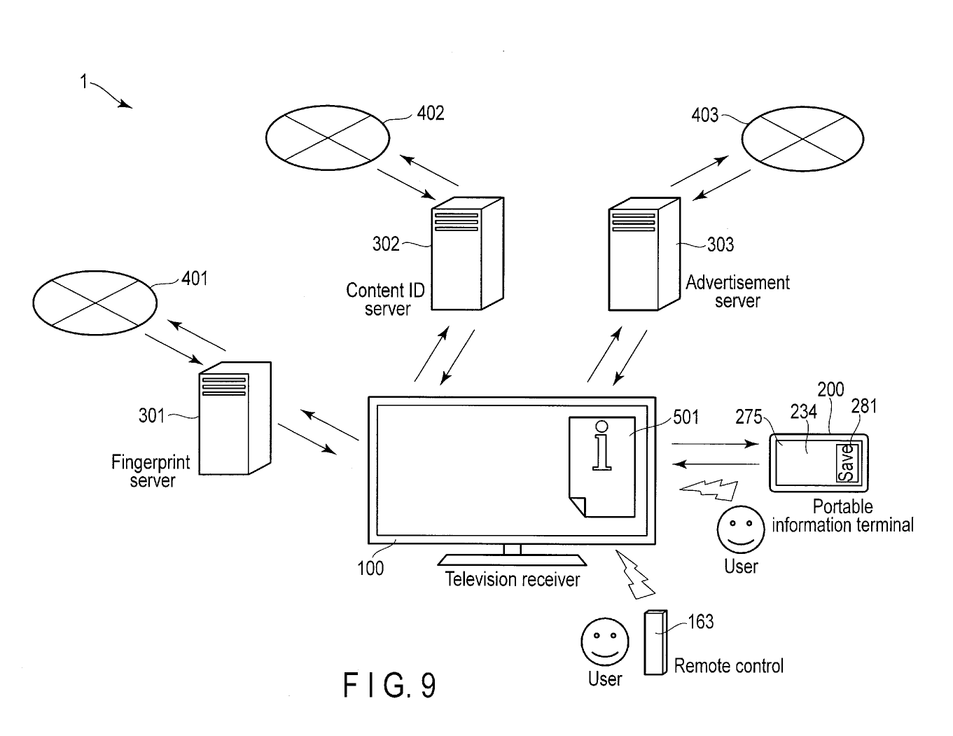

It should be noted that as shown in FIG. 9, an element which outputs the save signal is not limited to the remote controller 163; that is, the save signal may be output from the portable information terminal 200. In such a case, the application 275 for ACR is programmed to display a save button 281. If the save button 281 displayed in the application 275 for ACR is selected by an operation by the user, the portable information terminal 200 transmits a save signal to the television receiver 100. If receiving the save signal from the portable information terminal 200, the television receiver 100 transmits advertisement information of advertisement content 501 being viewed to the portable information terminal 200 through the LAN interface 171 or the near field communication module 174. If the portable information terminal 200 receives the advertisement information from the television receiver 100, the CPU 251 of the portable information terminal 200 stores the received advertisement information of the advertisement content 501 in the RAM 253 and the storage device 274. In this case, since the save signal can be transmitted from the remote controller 163 or the portable information terminal 200, the advertisement information can be stored in the portable information terminal 200 as long as the remote controller 163 or the portable information terminal 200 is present.

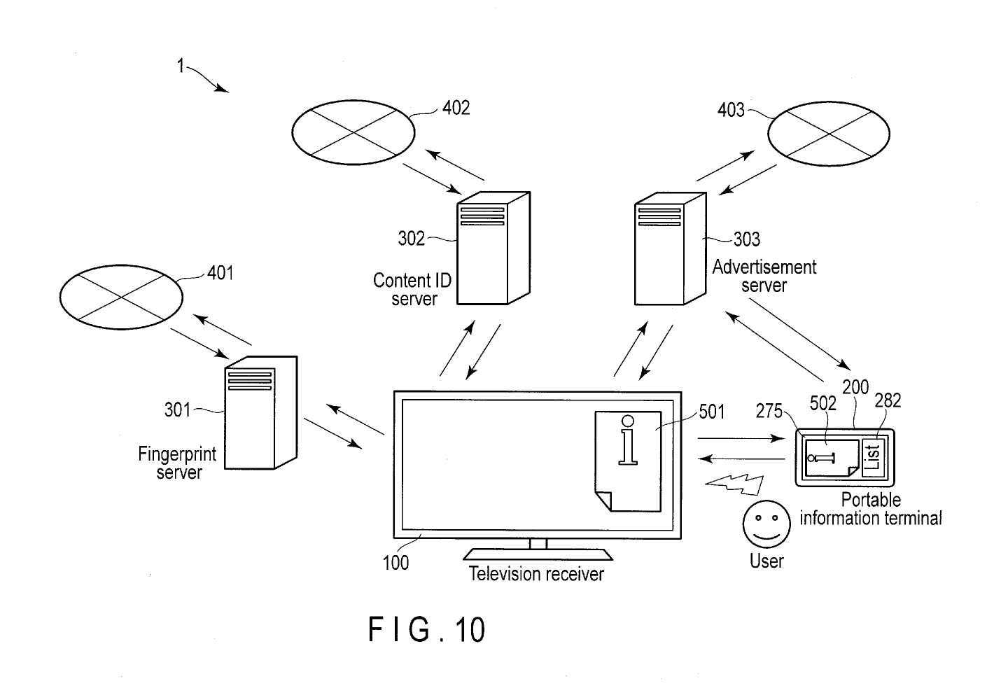

Also, as shown in FIG. 10, the application 275 for ACR may be programmed to display, during viewing operation, the advertisement content 502 for mobile phone on the portable information terminal 200. In this case, the television receiver 100 is connected to the communication line as the same time as the application 275 for ACR is started. From the television receiver 100, the advertisement information of the advertisement content 501 being viewed is transmitted to the portable information terminal 200 at all times. The portable information terminal 200 transmits the received advertisement information to the advertisement server 303, and acquires data of advertisement content 502 for mobile phone, from the advertisement server 303. The portable information terminal 200 displays the acquired advertisement content 502 for mobile phone, in the application 275 for ACR. At this time, the advertisement content 501 displayed by the television receiver 100 and the advertisement content 502 for mobile phone displayed by the portable information terminal 200 are information of the same advertisement. If the user selects the advertisement content 502 for mobile phone displayed by the portable information terminal 200 by performing an operation, advertisement information of the advertisement content 502 for mobile phone is saved in the application 275 for ACR. In such a case, the application for ACR may be programmed to display a list button 282 for displaying as a list, advertisement information saved in an image in which the advertisement content 502 for mobile phone is indicated. If the user selects the list button 282 by performing an operation such as a touch to the display or a button operation, advertisement information listed as described above is displayed.

In such a manner, in the case where advertisement information can be saved by selecting the advertisement content 502 for mobile phone, the user can confirm advertisement information to be saved visibly.

### Second Embodiment

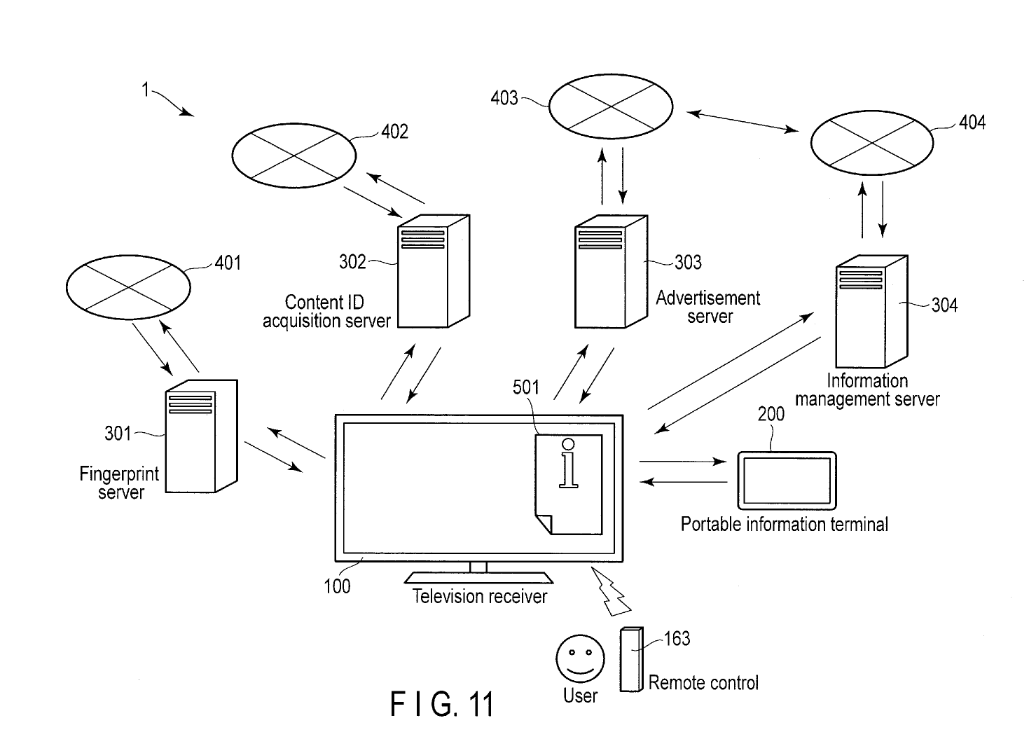

The second embodiment will be explained with reference to FIGS. 11-16. A transmission and reception system 1 according to the second embodiment has substantially the same structure as that according to the first embodiment. Therefore, with respect to the second embodiment, structural elements identical to those in the first embodiment will be denoted by the same reference numerals as in the first embodiment, and their detailed explanations will be omitted. The transmission and reception system 1 according to the second embodiment further comprises an information management server 304. In this regard, it is different from the transmission and reception system 1 according to the first embodiment.

The transmission and reception system 1 according to the second embodiment further comprises the information management server 304.

In the second embodiment, an advertisement server 303 further has a function of analyzing user preferences in content, based on information acquired through a network 403.

The information management server 304 holds management information, for example, a device identification number, a user ID, the number of clicks, acquired advertisement, the number of repetitions, kinds of content (programs and CMs) which was being viewed or delivered, etc., as a database. The information management server 304 collects advertisement information associated with the management information, from a network 404 or cloud service of the network 404 (or any other kind of server), and holds the collected advertisement information along with the management information as the database. The information management server 304 may further hold the advertisement information and the advertisement content 501, and also may function as the advertisement server 303. The information management server 304 can communicate with the television receiver 100 wirelessly or with a cable. The information management server 304 acquires management information from the television receiver 100. The information management server 304 can provide part of the management information to the advertisement server 303 through the networks 403 and 404. The information management server 304 can also communicate with the portable information terminal 200 wirelessly or with a cable. It should be noted that the information management server 304 may provide management information in response to a request from the television receiver 100.

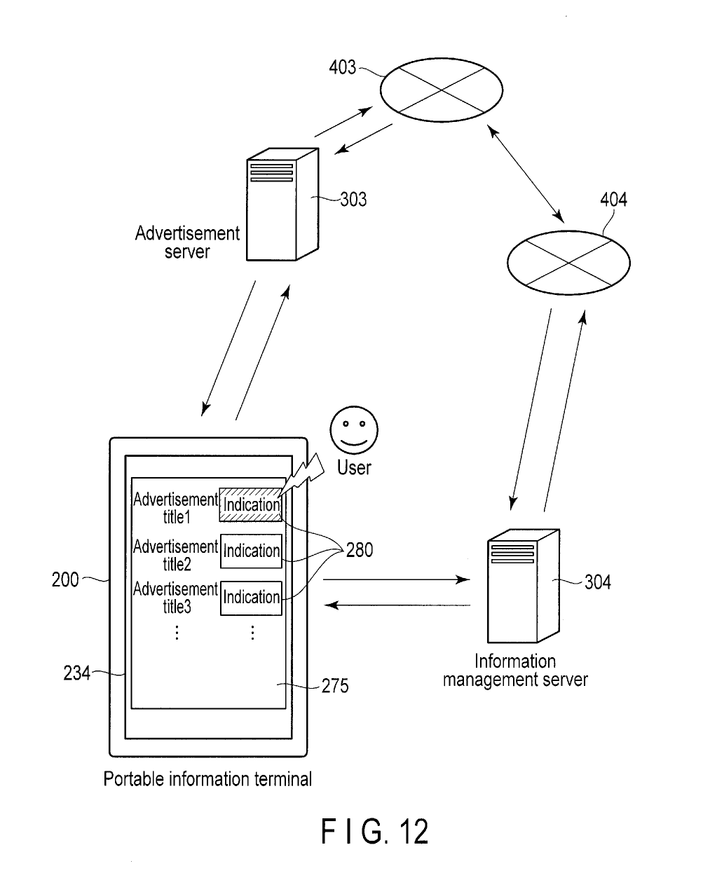

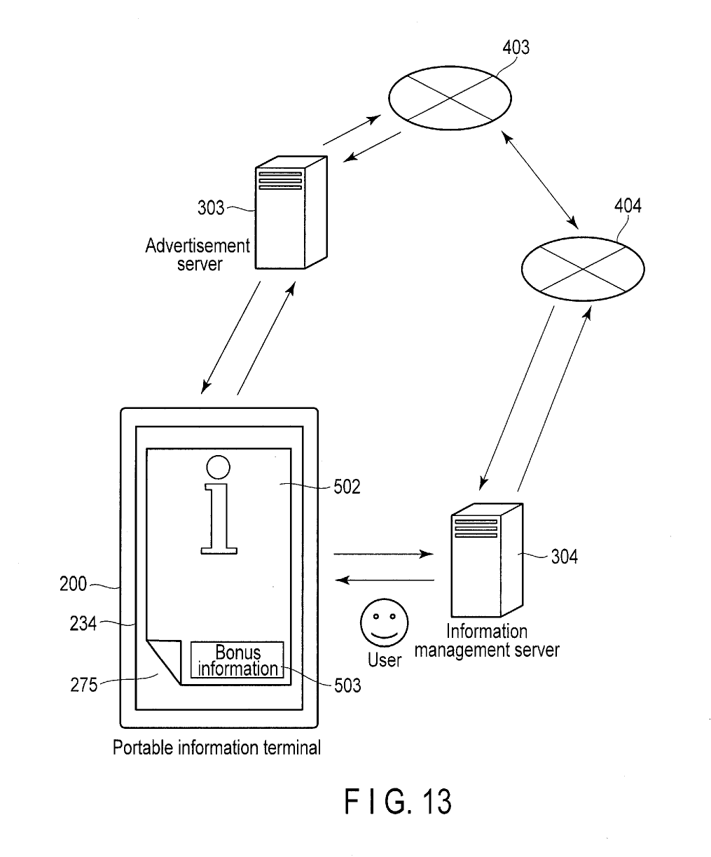

As shown in FIG. 12, in the portable information terminal 200 in the second embodiment, if a display button 280 for advertisement is selected by the user, the CPU 251 acquires advertisement content 502 for mobile phone from the advertisement server 303. Thereafter, an image displayed is changed from an image as shown in FIG. 12 to that as shown in FIG. 13, and the CPU 251 causes the acquired advertisement content 502 for mobile phone to be displayed in the application 275 for ACR. The advertisement content 502 for mobile phone also includes a bonus information icon 503 and advertisement content for mobile phone (individual advertisement content for mobile phone), which conforms to the user preferences. It should be noted that the individual advertisement content for mobile phone can be made undisplayed in accordance with a request from the user. The CPU 251 transmits management information such as information of an advertisement selected by the user, the number of times the display button is clicked, and a portable information terminal ID to the information management server 304. It should be noted that the bonus information icon 503 may be programmed selectable by an operation by the user. If the user selects the bonus icon 503, the CPU 251 acquires bonus information content from the advertisement server 303, and causes it to be displayed in the application 275 for ACR. At this time, the CPU 251 transmits information indicating that the user clicks the bonus information 503 to the management server 304. It should be noted that the application 275 for ACR may be programmed such that the number of times any of display buttons 280 is pressed is displayed in it.

Next, an example of processing of each of the television receiver 100, the portable information device 200 and the transmission and reception system 1 will be explained with reference to figures.

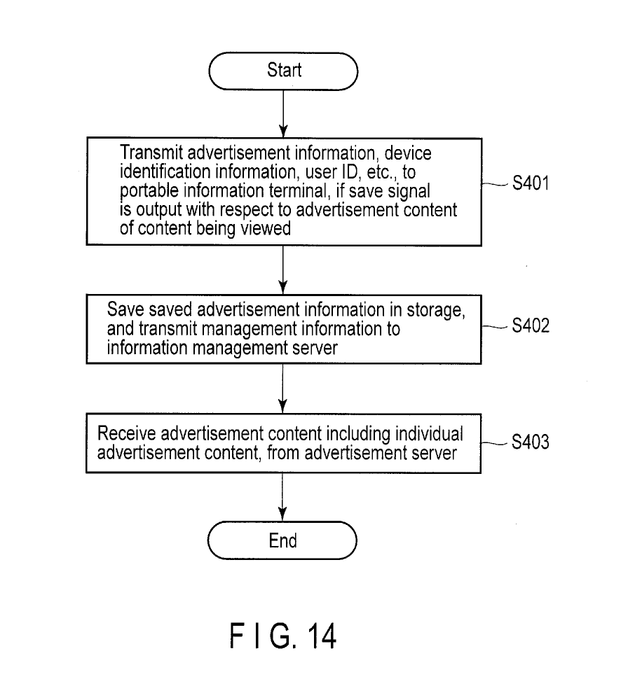

FIG. 14 is a flowchart showing an example of processing of the television receiver 100, which is associated with the information management server 304. In the second embodiment, processes of the television receiver 100 are executed until acquisition of the advertisement content 501 are equivalent to those in the first embodiment. Therefore, processing of acquisition by the television receiver 100 from the information management server 304 will be explained.

In S401, if a save signal is output with respect to advertisement content 501 of content being viewed, the CPU 151 transmits advertisement information of the advertisement content 501, a user ID and a device identification number of the television receiver 100, etc., to the portable information terminal 200. It should be noted that the user ID is a number for identifying a user who users the television receiver 100 or a number given by making a user registration in association with the television receiver, or the like. In S402, the CPU 251 stores in a storage 160, advertisement information saved by the user, and transmits management information, for example, the stored advertisement information, a user ID, a device identification number, etc., to the information management server 304. The advertisement server 303 analyzes user preferences from information acquired from the information management server 304. In S403, the television receiver 100 receives from the advertisement server 303, advertisement content 501 including advertisement content (individual advertisement content) conforming to the user preferences. It should be noted that the CPU 151 can make the individual advertisement content of the advertisement content displayed or undisplayed in accordance with a request from the user.

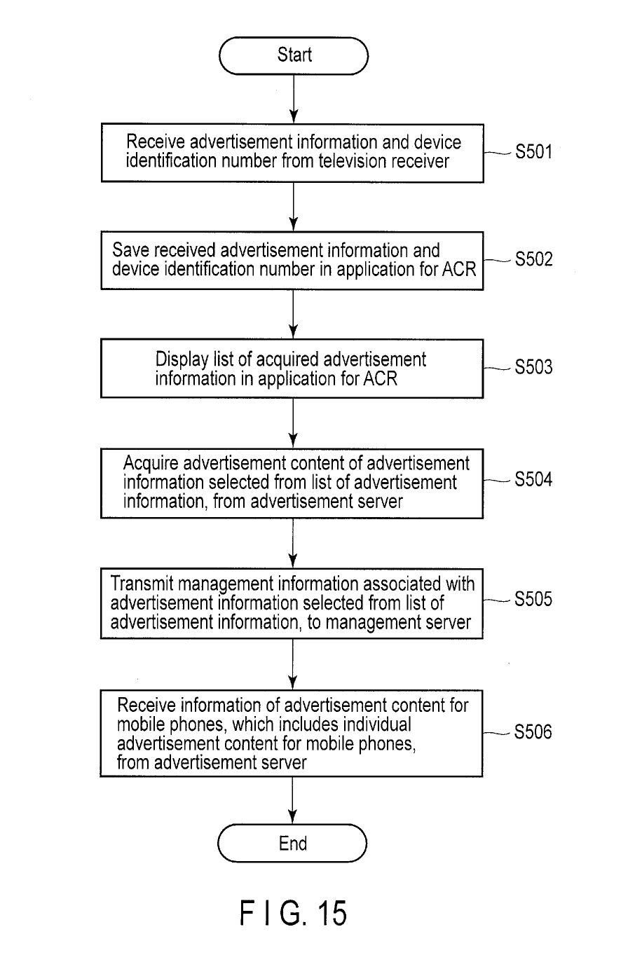

FIG. 15 is a flowchart showing an example of processing of the portable information terminal 200, which is associated with the information management server 304. In the second embodiment, advertisement information of advertisement content 501 being viewed is acquired from the television receiver 100, and processing of acquiring advertisement content 502 for mobile phone, from the advertisement server 303, is substantially the same as that in the first embodiment.

In S501, the portable information terminal 200 receives from the television receiver 100, advertisement information and a device identification number of the television receiver 100, which are to be saved. In S502, the received advertisement information and device identification number are saved in the application 275 for ACR (the storage device 274). In S503, the CPU 251 makes a list of advertisement titles of the advertisement information, and causes the list to be displayed in a displayed image of the application 275 for ACR. In S504, if the user selects a display button 280 for advertisement content to be confirmed, the CPU 251 acquires the advertisement content 502 from the advertisement server 303. In S505, the CPU 251 transmits management information to the information management server 304. It should be noted that the information management server 304 provides part of the management information to the advertisement server 303, and the advertisement server 303 analyzes the user preferences based on the part of management information. In S506, information of advertisement content 502 for mobile phone, which includes individual advertisement content for mobile phone, is acquired from the advertisement server 303. At this time, the CPU 251 can cause the individual advertisement content for mobile phone of the advertisement content 502 for mobile phone to be displayed/undisplayed, in accordance with a request from the user.

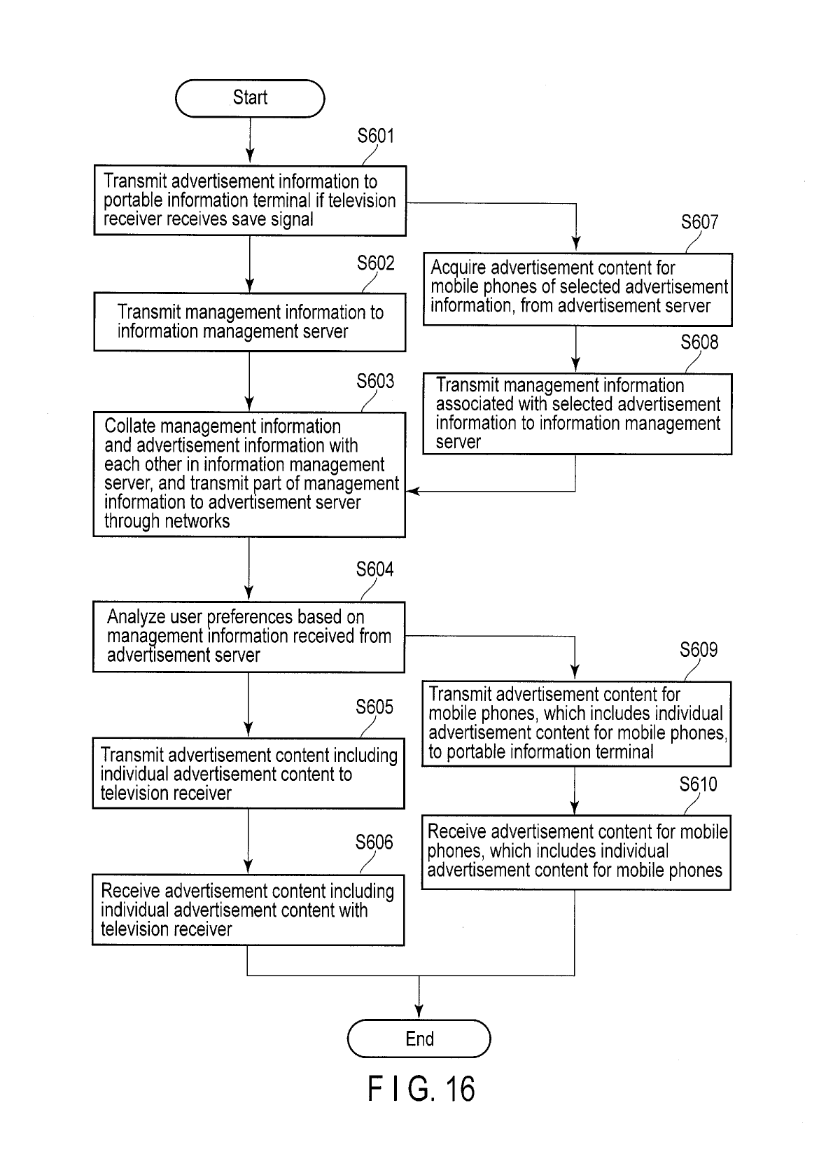

FIG. 16 is a flowchart of processing of the transmission and reception system 1, which is associated with the information management server 304. In the second embodiment, processes which are executed until the television receiver 100 acquires the advertisement content 501 are equivalent to those in the first embodiment.

In S601, if the television receiver 100 receives a save signal, the television receiver 100 transmits advertisement information to the portable information terminal 200. Then, in S602, the television receiver 100 transmits management information to the information management server 304. In S603, the information management server 304 collates the received management information and advertisement information with each other, and transmits part of the management information to the advertisement server 303 through the networks 403 and 404. In S604, the advertisement server 303 analyzes the user preferences from the received part of the management information. In S605, the advertisement server 303 collates the user preferences and advertisement content with each other, and transmits individual advertisement content to the television receiver 100. In S606, the television receiver 100 receives advertisement content 501 including the individual advertisement content. The television receiver 100 can cause the individual advertisement content of the advertisement content 501 to be displayed or undisplayed in accordance with a request from the user.

In S607 subsequent to S601, the portable information terminal 200 selects advertisement information to be displayed, from the received advertisement information, and acquires advertisement content 607 for mobile phone, from the advertisement server 303. The portable information terminal 200 transmits management information associated with the advertisement information selected by the user to the information management server 304, and advances to the process of S603.

In S609 subsequent to S604, the advertisement server 303 transmits advertisement content 502 for mobile phone, which includes the individual advertisement content, to the portable information terminal 200. In S610, the portable information terminal 200 receives the advertisement content 502 for mobile phone, which includes the individual advertisement content. It should be noted that the portable information terminal 200 can cause the individual advertisement content for mobile phone of the advertisement content 502 for mobile phone to be displayed/undisplayed in accordance with a request from the user.

According to the second embodiment, the television receiver 100 and the portable information terminal 200 can manage information associated with an operation performed by the user, or advertisement information selected by the user, or the like, in the information management server 304. Furthermore, the transmission and reception system 1 can provide advertisement information conforming to the user preferences by acquiring part of the management information managed by the information management server 304.

### Third Embodiment

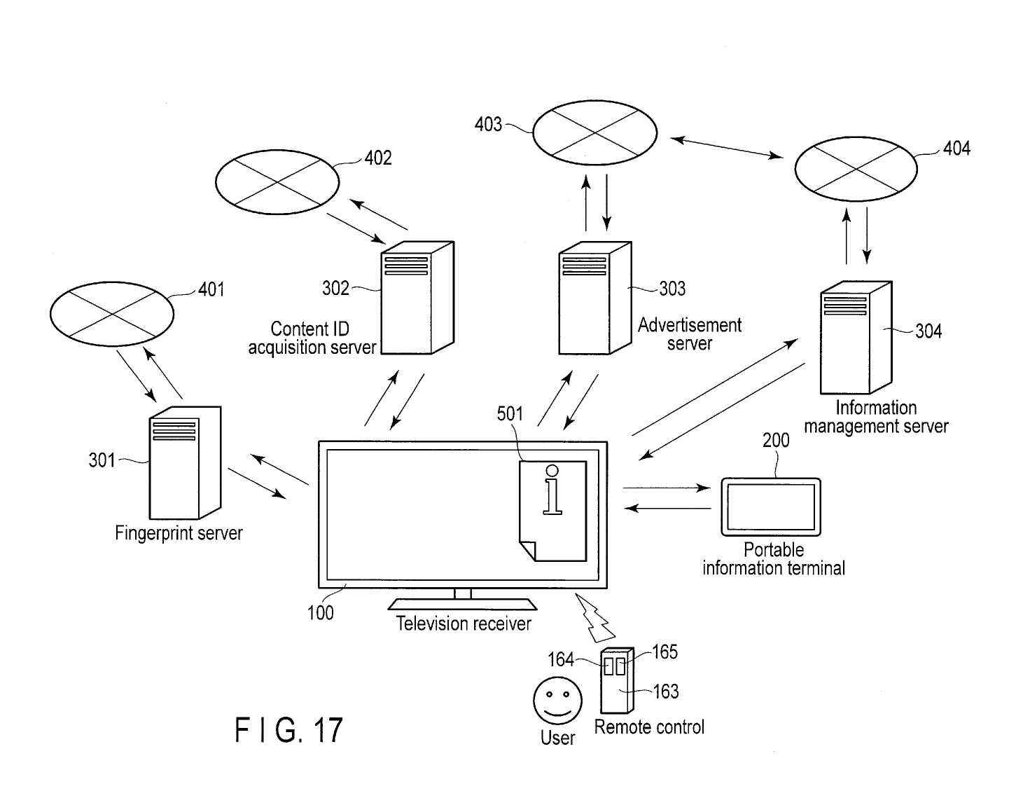

The third embodiment will be explained with references to FIGS. 17-22. A transmission and reception system 1 according to the third embodiment has substantially the same structure as that according to the second embodiment. Therefore, with respect to the third embodiment, structural elements identical to those in the second embodiment will be denoted by the same reference numerals as in the second embodiment, and their detailed explanations will be omitted. The transmission and reception system 1 according to the second embodiment can record advertisement information not selected, and in this regard, it is different from the transmission and reception system 1 according to the first embodiment.

In the third embodiment, a television receiver 100 can store all advertisement content displayed in content being viewed, in the storage 160, or in an external recording device connected to it by an external interface module 173. Saving of all the advertisement content displayed in the content being viewed will be hereinafter referred to as a “complete save” function. It should be noted that if the volume of advertisement content acquired by the “complete save” function is not large, the acquired advertisement content may be saved in an information management server 304.

The remote controller 163 comprises a save button 164 for saving advertisement information of advertisement content 501 being viewed and a complete save button 165 for performing “complete save”. It should be noted that in an ordinary remote control for a TV for terrestrial digital broadcasting, the save button 164 and the complete save button 165 may be provided as a blue button and a red button, respectively. Advertisement information saved in response to a save signal output in accordance with a request from the user will be referred to as “selected advertisement information”, and advertisement information saved by the “complete save” function will be referred to as “completely saved” advertisement information.

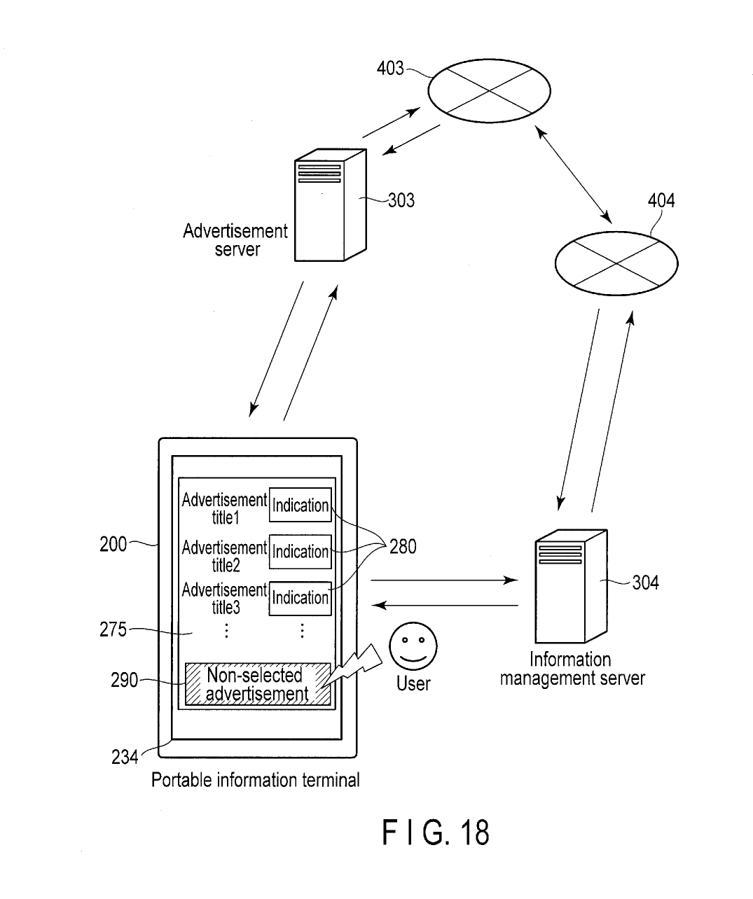

FIG. 18 is a view showing an outline of the portable information terminal 200 according to the third embodiment. If an application 275 for ACR is started, the portable information terminal 200 receives “completely saved” advertisement information from the television receiver 100, for example, an advertisement ID, an advertisement title and a device identification number. The portable information terminal 200 saves the “completely saved” advertisement information in the application 275 for ACR (storage device 274). Furthermore, if the save button 164 is pressed by the user, the portable information terminal 200 receives selected advertisement information from the television receiver 100. At this time, the CPU 251 separates the selected advertisement information from the “completely saved” advertisement information saved in the application 275 for ACR.

As shown in FIG. 18, in the portable information terminal 200 in the third embodiment, the application 275 for ACR includes a button (non-selected advertisement display button) 290 for listing in the “completely saved” advertisement information, advertisements (non-selected advertisements) for which the save button 164 was not pressed by the user. The CPU 251 is programmed to display a list of titles of non-selected advertisements in a displayed image of the application 275 for ACR if the non-selected advertisement display button 290 is selected by the user.

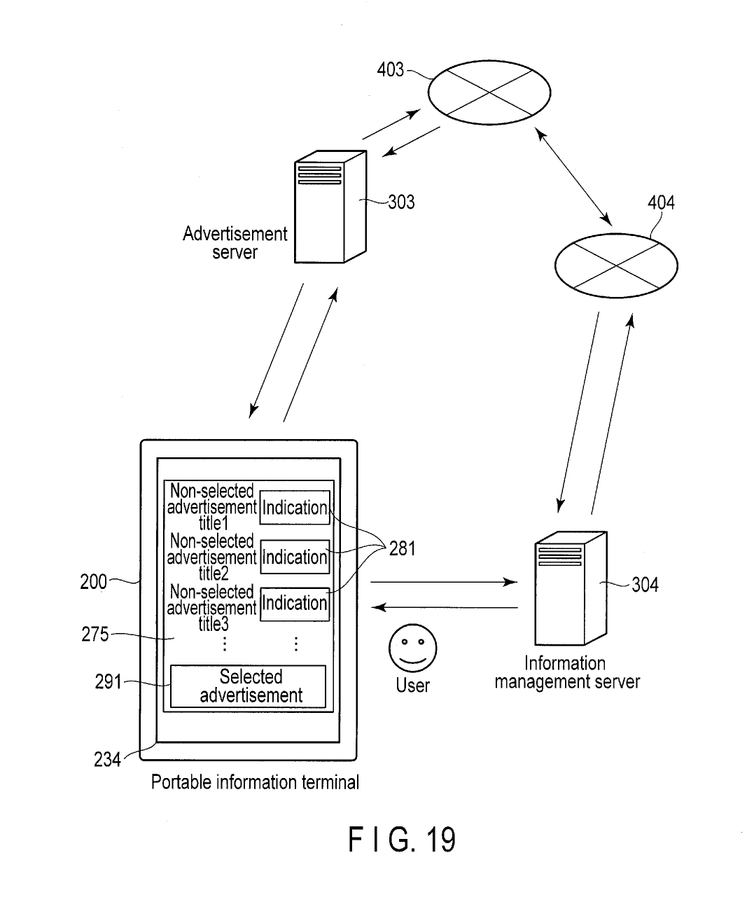

If the displayed image is changed from that as shown in FIG. 18 to that as shown in FIG. 19, a list of titles of non-selected advertisement information is displayed. In the displayed image of the application 275 for ACR, save buttons 281 are each displayed as a button for changing non-selected advertisement information to selected advertisement information. If the user presses “complete save” button 281, the portable information device 200 receives the “completely saved” advertisement information from the television receiver 100, and saves it in the application 275 for ACR.

Next, examples of processing of the television receiver 100, the portable information device 200 and the transmission and reception system 1 will be explained with reference to figures.

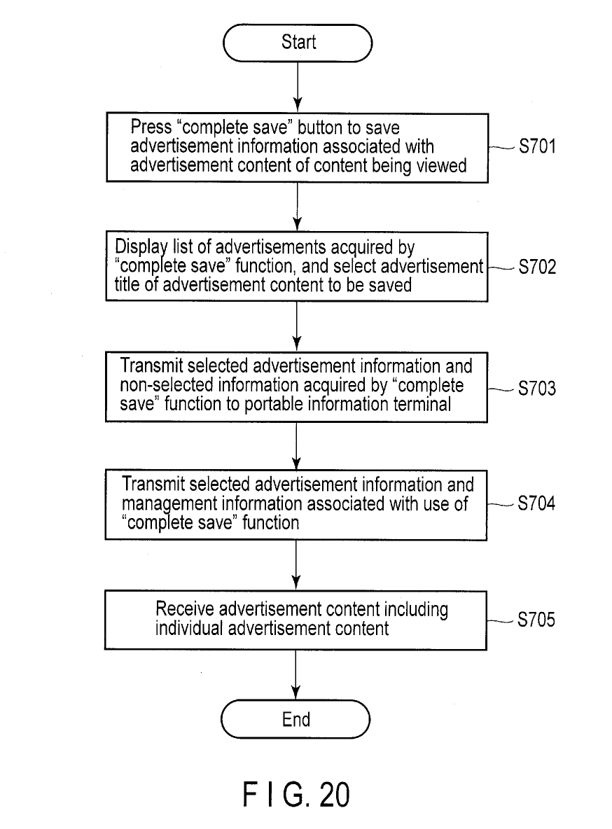

FIG. 20 is a flowchart showing an example of the processing of the television receiver 100. In the third embodiment, processes which are executed until the television receiver 100 transmits advertisement information to the portable information terminal 200 are the same as those in the second embodiment. Therefore, processing of a “complete save” function will be explained.

In S701, if a save signal is output with respect to advertisement content 501 of content being viewed, the CPU 151 saves all advertisement content 501 which is provided until the content being viewed ends, in the storage 160 or a memory device connected to it by the external interface module 173 or the like. The CPU 151 separates “completely saved” advertisement information into selected advertisement information and non-selected advertisement information. The controller 150 determines ending of the content being viewed, from a signal input from the input module 111.

In S702, the television receiver 100 can display a list of non-selected advertisement information in the “completely saved” advertisement information acquired by the “complete save” function in accordance with a request from the user. The user can select an advertisement to be saved, from the list displayed using the remote controller 163. It should be noted that the television receiver 100 can display a list of “completely saved” advertisement information in accordance with a request from the user, even if it is being viewed, and for example, by pressing the save button 164, the non-selected advertisement information can be saved as selected advertisement information.

In S703, the CPU 151 transmits the selected advertisement information and non-selected advertisement information acquired by the “complete save” function, a user ID and a device identification number of the television receiver 100, etc., to the portable information terminal 200. In S704, the CPU 151 transmits selected advertisement information and management information, e.g., the number of times the “complete save” function is used, to the information management server 304. In S705, the advertisement server 303 analyzes user preferences from information acquired from the information management server 304 through the network 403. The television receiver 100 receives advertisement content 501 including individual advertisement content from the advertisement server 303. The CPU 151 can make the individual advertisement content displayed/undisplayed in accordance with a request from the user.

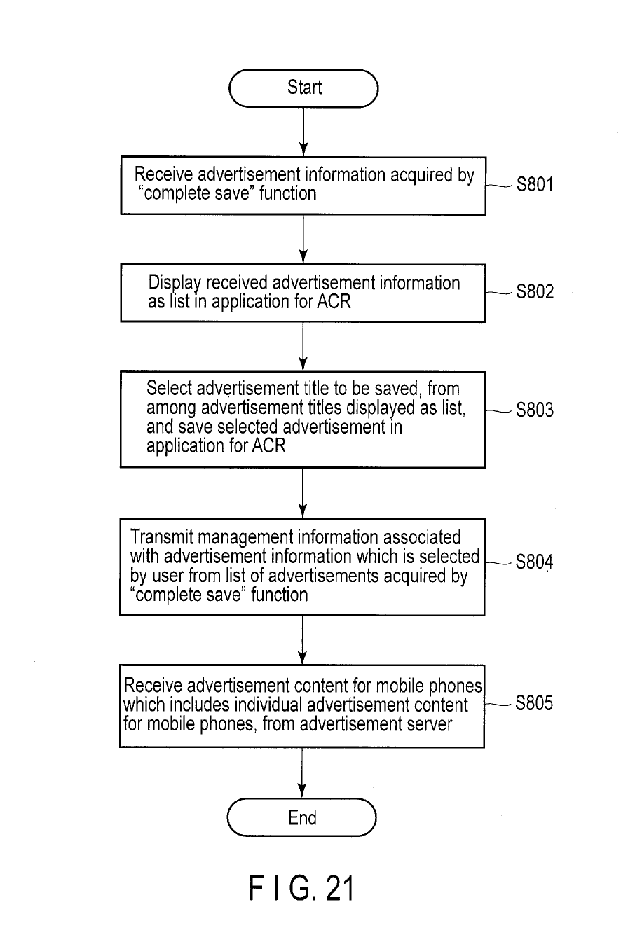

FIG. 21 is a flowchart showing an example of processing of the portable information terminal 200. The processing of the portable information terminal 200 in the third embodiment is substantially the same as that in the second embodiment. Therefore, processing associated with the advertisement information acquired by the “complete save” function will be explained.

In S801, the portable information terminal 200 receives advertisement information, a device identification number, a user ID, etc., from the television receiver 100. At this time, the CPU 251 saves selected advertisement information, non-selected advertisement information, a device identification number, a user ID, etc., which are received from the television receiver 100, in the application 275 for ACR (storage device 274). In S802, the CPU 251 causes a list of non-selected advertisement information to be displayed in a displayed image of the application 275 for ACR in accordance with a request from the user. In S803, if a save button 281 is selected by an operation by the user to save non-selected advertisement information, the CPU 251 saves the non-selected advertisement information in the application 275 for ACR. In S804, the CPU 251 transmits information indicating that the non-selected advertisement information is saved as selected information, as management information, to the information management server 304. In this case, the information management server 304 provides part of the management information to the advertisement server 303, and the advertisement server 303 analyzes user preferences based on the part of the management information. In S805, advertisement content 502 for mobile phone which includes individual advertisement content for mobile phone is acquired from the advertisement server 303. At this time, the CPU 251 can cause the individual advertisement content for mobile phone to be displayed/undisplayed in accordance with a request from the user.

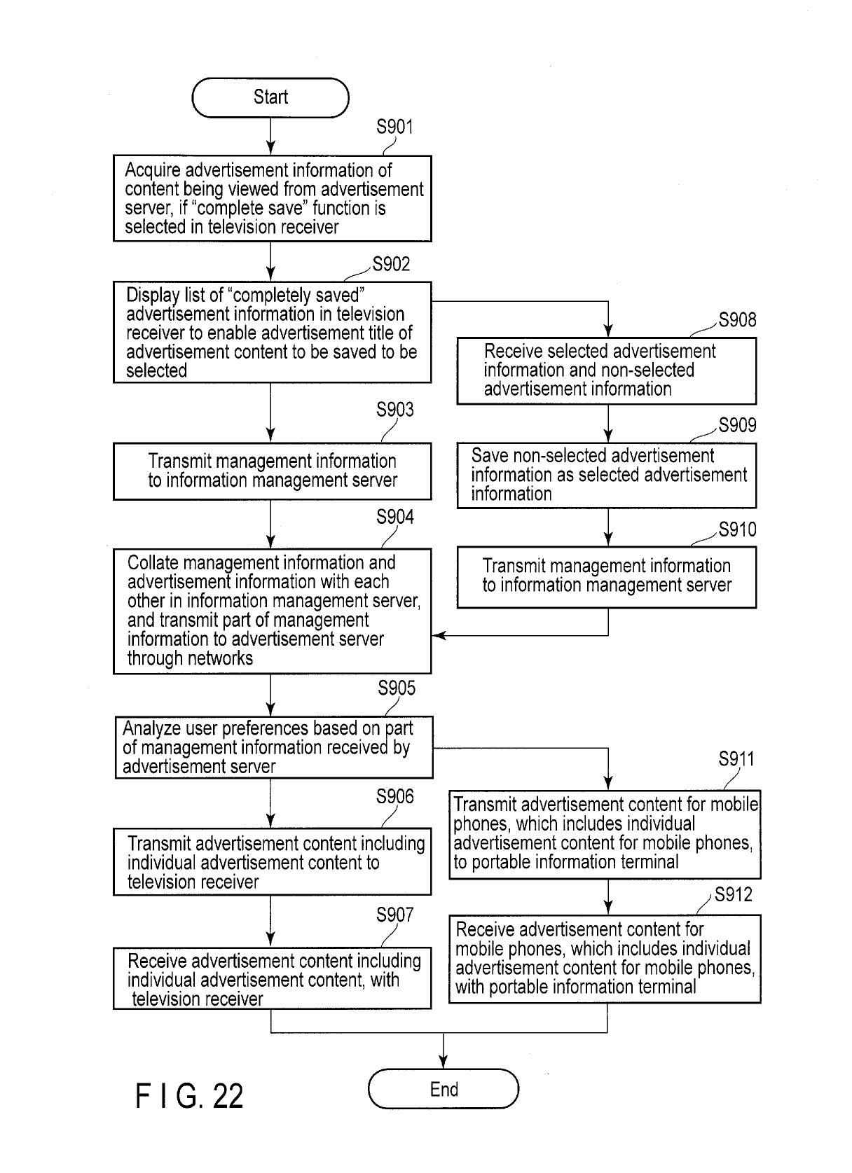

FIG. 22 is a flowchart showing an example of processing of the transmission and reception system 1. The processing of the transmission and reception system 1 in the third embodiment is substantially the same as that in the second embodiment. Therefore, processing associated with the “complete save” function will be explained.

In S901, if the “complete save” function is selected, the television receiver 100 acquires advertisement information of content being viewed, from the advertisement server 303. The acquired advertisement information is saved in the storage 160 or an external storage device connected to it by the external interface module 173. In S902, the television receiver 100 displays a list of non-selected advertisement information saved by the “complete save” function in accordance with a request from the user. The television receiver 100 saves in the storage 160, non-selected information selected from the list, as selected advertisement information. In S903, the television receiver 100 transmits selected advertisement information and non-selected advertisement information which are saved in the “complete save” function, a device identification number, a user ID, etc., to the portable information terminal 200, and also management information to the information management server 304.

In S904, the information management server 304 collates the management information and advertisement information with each other, and transmits part of the management information to the advertisement server 303 through the networks 403 and 404. In S905, the advertisement server 303 analyzes user preferences based on the part of the management information. In S906, the advertisement server 303 transmits advertisement content 501 including individual advertisement information conforming to the analyzed user preferences to the television receiver 100. In S907, the television receiver 100 receives the advertisement content 501 including the individual advertisement content conforming to the user preferences. The television receiver 100 can cause the individual advertisement content of the advertisement content 501 to be displayed/undisplayed in accordance with a request from the user.

In S908 subsequent to S902, the portable information terminal 200 receives the advertisement information (selected advertisement information and non-selected advertisement information), the device identification number, the user ID, etc. In S909, the portable information terminal 200 saves the non-selected advertisement information as selected advertisement information in the application 275 for ACR in accordance with a request from the user. In S910, the portable information terminal 200 transmits information indicating that the non-selected advertisement information is saved as selected advertisement information to the information management server 304, and proceeds to the process of S904.

In S911 subsequent to S905, the advertisement server 303 transmits advertisement content 502 for mobile phone which includes individual advertisement content for mobile phone to the portable information terminal 200. In S912, the portable information terminal 200 receives the advertisement content 502 for mobile phone, which includes the individual advertisement content. It should be noted that the portable information terminal 200 can cause the individual advertisement content for mobile phone of the advertisement content 502 for mobile phone to be displayed/undisplayed in accordance with a request from the user.

According to the third embodiment, using the “complete save” function, the user can save advertisement information which the user forgets to save during viewing, after or during the viewing.

According to some embodiments described above, the television receiver 100 can save advertisement information associated with content being viewed, in the portable information terminal 200. As a result, regardless of time and place, the user can cause the portable information terminal 200 to display advertisement information saved during viewing with the television receiver 100, at an arbitrary timing. Furthermore, if the advertisement information includes bonus information, it can also be applied to service in which the user can obtain a bonus by presenting a displayed image including bonus information to a shop or the like.

It should be noted that in the embodiments described above, in the case where the advertisement information is confirmed (displayed) in the portable information terminal 200, the application for ACR is used: however, it may be set as a structure that the advertisement information can be confirmed through the Internet with a browser or the like. In this case, for example, it may be set that the television receiver 100, the advertisement server 303 or the information management server 304 holds the advertisement information, and the advertisement information can be confirmed wirelessly or with a cable, with a browser.

In addition, in the above embodiments, the save signal is output from the remote controller 163 or the portable information terminal 200; however, a specific operation by the user may be detected as a save signal by the camera 191 of the television receiver 100.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image display apparatus comprising:
an auto content recognition module configured to automatically recognize a feature of content delivered;
a communication module configured to transmit and receives information to and from an external information terminal; and
a controller configured to acquire advertisement information associated with the content from a server which stores the advertisement information associated with the content, based on the feature of the content which is recognized by the auto content recognition module, and configured to transmit the advertisement information to the external information terminal in response to an operation by a user which is performed as a trigger.

2. The image display apparatus of claim 1, wherein if detecting the operation by the user performed as the trigger, the controller transmits the advertisement information to the external information terminal.

3. The image display apparatus of claim 2, further comprising a signal device configured to output a signal for causing the processor to transmit the advertisement information to the external information terminal.

4. The image display apparatus of claim 3, wherein the operation by the user is performed using the signal device.

5. The image display apparatus of claim 4, wherein if receiving the signal transmitted from the signal device, the controller transmits the advertisement information to the external information terminal.

6. The image display apparatus of claim 5, wherein the signal device is the external information terminal.

7. An external information terminal comprising:
a reception module configured to receive advertisement information associated with first content which is transmitted by an image display apparatus; and
a display controller configured to cause an advertisement title and a button to be displayed, the advertisement title being included in the advertisement information received by the reception module, the button being provided to cause second content associated with the advertisement title to be viewed, and configured to cause the second content to be displayed when the button is pressed.

8. The external information terminal of claim 7, wherein the display controller causes bonus information to be displayed, the bonus information being provided as a bonus associated with the second content.

9. A program to be executed by an external information terminal comprising a communication module configured to transmit and receives information, and a screen on which a display associated with the information is allowed to be made, the program causing the external information terminal:
receiving from an image display apparatus, advertisement information associated with content which is delivered to the image display apparatus through the communication module, and displayed by the image display apparatus, from the image display apparatus;
acquiring the first content form a server which stores the first content, the first content being provided as an advertisement associated with the received advertisement information; and
displaying the acquired first content as second content conforming to the external information terminal.

10. The program of claim 9, further comprising:
displaying along with the second content, the bonus information which is provided as the bonus associated with the second content.

11. The program of claim 10, further comprising:
counting the number of times the second content is displayed, and transmitting the number of times to an external server.
